(19) United States
(12) Patent Application Publication
(10) Pub. No.: US 2019/0377405 A1
(43) Pub. Date: Dec. 12, 2019

(54) Input Voltage Protection

(71) Applicant: Intel Corporation, Santa Clara, CA (US)

(72) Inventors: Alexander B. Uan-Zo-li, Hillsboro, OR (US); Eugene Gorbatov, Hillsboro, OR (US); Philip R. Lehwalder, Hillsboro, OR (US); Michael Zelikson, Haifa (IL); Sameer Shekhar, Portland, OR (US); Nimrod Angel, Haifa (IL); Jonathan Douglas, Portland, OR (US); Muhammad Abozaed, Haifa (IL); Alan Hallberg, North Plains, OR (US); Douglas Huard, Portland, OR (US); Edward Burton, Hillsboro, OR (US); Merwin Brown, El Dorado Hills, CA (US)

(73) Assignee: Intel Corporation, Santa Clara, CA (US)

(21) Appl. No.: 16/369,529

(22) Filed: Mar. 29, 2019

(51) Int. Cl. G06F 1/3296; G06F 1/3206; G05F 1/625

(52) U.S. Cl. CPC G06F 1/3296; G05F 1/625; G06F 1/3206

(57) ABSTRACT

In some examples, a voltage protection apparatus includes a circuit to compare an input voltage of a processor to a threshold voltage, and to provide a throttle signal to the processor if the input voltage of the processor droops below the threshold voltage. The processor input voltage can then be set to a lower voltage and the processor power can thus be lowered.

### TECHNICAL FIELD

This disclosure relates to using a throttle to a processor to protect the input voltage. For example, this disclosure also relates to allowing a processor (for example, a Central Processing Unit or CPU) to operate at lower voltage levels, and/or protecting the processor from black-screening.

### BACKGROUND

It is becoming more difficult to improve processor performance, Central Processing Unit (CPU) performance, and/or System on Chip (SoC) performance through new silicon processes. This can result in an increase of peak power of the SoC (and/or of the processor). In addition, leakage can become a higher and higher percentage of total processor or SoC power consumption, for example. From a dynamic current standpoint, power virus (PV) current may continue to grow.

It can be important to limit processor core voltage or VID (voltage identification, core voltage, and/or functional voltage), and it is critical to make sure that the core voltage does not drop below a minimum value such as a minimum value defined by a CPU process and frequency. Therefore, in some power delivery (PD) implementations, required voltage settings might be calculated using PV current values. However, increasing a current ratio such as I(PV)/I(App) (a ratio of power virus current to application current) can lead to a substantial increase in a functional voltage such as VID, and can lead to power and performance penalties.

### BRIEF DESCRIPTION OF THE DRAWINGS

The following detailed description may be better understood by referencing the accompanying drawings, which contain specific examples of numerous features of the disclosed subject matter.

FIG. 1 illustrates a system in accordance with some embodiments;

FIG. 2 illustrates a system in accordance with some embodiments;

FIG. 3 illustrates a system in accordance with some embodiments;

FIG. 4 illustrates a timing diagram in accordance with some embodiments;

FIG. 5 illustrates a system in accordance with some embodiments;

FIG. 6 illustrates a timing diagram in accordance with some embodiments;

FIG. 7 illustrates a system in accordance with some embodiments;

FIG. 8 illustrates a system in accordance with some embodiments;

FIG. 9 illustrates a system in accordance with some embodiments;

FIG. 10 illustrates a system in accordance with some embodiments;

FIG. 11 illustrates a system in accordance with some embodiments;

FIG. 12 illustrates a system in accordance with some embodiments;

FIG. 13 illustrates a system in accordance with some embodiments;

FIG. 14 illustrates a system in accordance with some embodiments;

FIG. 15 illustrates a computing system in accordance with some embodiments;

FIG. 16 illustrates one or more processors and one or more medium in accordance with some embodiments;

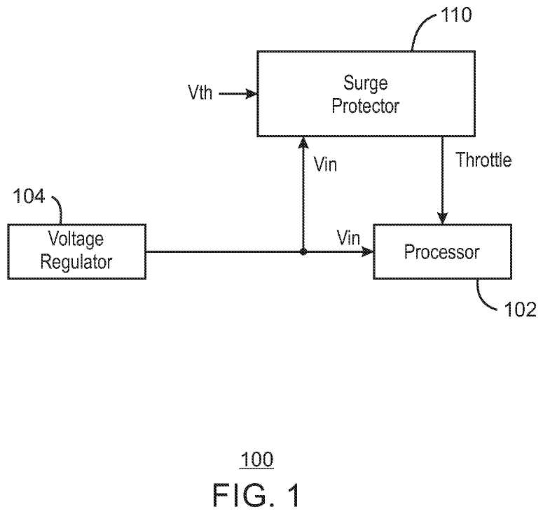

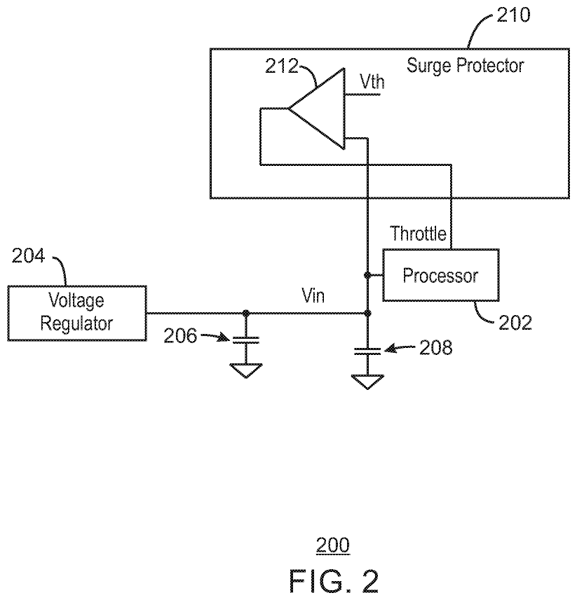

In some cases, the same numbers are used throughout the disclosure and the figures to reference like components and features. In some cases, numbers in the 100 series refer to features originally found in FIG. 1; numbers in the 200 series refer to features originally found in FIG. 2; and so on.

### DESCRIPTION OF THE EMBODIMENTS

Some embodiments relate to power surge protection. Some embodiments relate to a surge protector that can improve performance and lower power consumption (for example, a surge protector that can improve performance and lower power consumption of one or more processor, and/or of one or more processor core). Some embodiments relate to allowing a processor (for example, a Central Processing Unit or CPU) to operate at lower voltage levels (for example, by protecting the processor from black-screening). Some embodiments allow a processor input voltage to be set at a level below a level required by the maximum processor current and minimum processor voltage, without risk of violating the minimum processor voltage.

Some embodiments relate to using a throttle to a processor (and/or a throttle to a processor core) to protect input voltage from drooping below a minimum value (for example, to protect processor input voltage from drooping below a minimum value). In some embodiments, if processor input voltage droops, the input voltage is sustained as long as possible while throttling the processor. For example, in some embodiments, when the input voltage approaches a threshold voltage level (or a minimum voltage level), for example, a comparator monitoring the input voltage may send a throttle signal to the processor to throttle the processor. In addition, in some embodiments, enough power may be provided to create enough time for the throttling mechanism to work, supplementing the power coming from the main power source of the processor.

In accordance with some embodiments, throttling the processor may include, for example, adjusting a clock speed of the processor. This can also be referred to, for example, as dynamic frequency scaling. Processor throttling (for example, Central Processing Unit throttling) can be used to automatically slow down the processor in order to use less energy and conserve battery, for example. Processor throttling can include adjusting the frequency of the processor, which can help to conserve power and to reduce the amount of heat generated by the processor, for example. Throttling the processor can also include stopping of execution of certain instructions (for example, stopping execution of instructions that are not providing a lot of value). Additionally, throttling of the processor can include decreasing dynamic capacitance (Cdyn) of the processor. Throttling of the processor may also include addition of instructions in the pipeline that are known to require little energy.

In some embodiments, since voltage threshold protection is implemented, the VID (processor voltage identification, core voltage, and/or functional voltage) may be set to a lower value than it might otherwise be set. Since power consumed by the processor is proportional to voltage squared (v²), less processor power consumption is possible when setting the VID to a lower level. This can allow a higher processor frequency setting.

As discussed above, limiting processor core voltage or VID can be important. This can be implemented, for example, by making sure that the VID (voltage identification, core voltage, and/or functional voltage) does not drop below a minimum value. Therefore, in some power delivery (PD) implementations, required voltage settings might be calculated using PV current values. However, increasing a current ratio such as I(PV)/I(App) (a ratio of power virus current to application current) can lead to a substantial increase in a functional voltage such as VID, and can lead to power and performance penalties.

Processor core voltage such as Central Processing Unit (CPU) core voltage can be set based on parameters in the core and the motherboard (MB), which add to the minimum core voltage. These parameters may include one or more of:

Maximum core current (Imax)

Motherboard (MB) load line (LL), which can include AC load line and DC load line

Motherboard voltage regulator (MB VR) inaccuracy of its output voltage due to ripple, DC offset, and load line inaccuracy such as voltage tolerance band (TOB)

Additional guard band in manufacturing including reliability, load line such as LL2 and LL1, wear-out, etc. (product guard band to ensure quality and reliability).

Parameters such as those mentioned above can increase input voltage to processor cores. It is noted that in many cases realistic core peak current (peak Icore) may be much lower than maximum current virus (Imax virus) since application of dynamic capacitance (Cdyn) is much lower than a worst case dynamic capacitance (worst case Cdyn). Additionally, a majority of motherboard voltage regulators (MB VRs) may not exhibit the worst case scenario that may be used to calculate the voltage tolerance band (TOB). Further, product guard bands may be estimated for virus conditions, and may take into account a load line voltage droop (for example, the LL2 voltage droop). Higher voltage can have a large impact on processor power consumption, since dynamic power is proportional to voltage squared (v²), and leakage power is proportional to at least voltage cubed (at least v³).

Some SoC power delivery implementations use one or more fully integrated voltage regulators (FIVR), which can enable load lines near zero (practically zero LL3 and LL2, for example). A non-linear controller (NLC, such as an NLC2) can be used to mitigate effects of the first droop. In order to reduce current provided by a motherboard voltage regulator (MB VR), for example, such as a MBVR connected to an input rail of an FIVR, the processor may implement a throttling of the SoC if the current exceeds a given value.

Power associated with a high-frequency band may be detected and throttled in some implementations. A non-linear controller (NLC) can be used as a safety net for short-term fast droops of processor core voltage. However, due to a constantly increasing processor core output voltage and a drop on an FIVR input net, an efficiency of the NLC may be diminishing. In order to cope with fast transients, a low impedance connection between the FIVR input voltage and the output plane of the processor core may be enabled.

In some embodiments, advantageous benefits may be enabled without requiring an underlying framework of a fully integrated voltage regulator (FIVR). Mid-frequency behavior (for example, from DC to a couple of tens of MHz) may be monitored and managed in accordance with some embodiments. Some embodiments use an alternative power source connected to the processor (for example, to the CPU, the SoC, the processor core, etc.) using a switchable and controllable path. An on-die dedicated circuit may be used to monitor the voltage on package decoupling capacitors. When the voltage (or its time derivative, or its time integral, or a combination of two or more of the voltage, its time derivative, and its time integral) crossed a pre-defined threshold, a signal may be sent to request processor throttling (for example, CPU, SoC, and/or core throttling), and the path connecting the processor to the alternate power source may be switched to low impedance, allowing additional current flow into the processor (for example, into the CPU, SoC, and/or core, etc.) In this manner, excess current (for example, above-threshold current) demand may be supported until it decays following a throttling event.

In some embodiments, an additional power source may be used to prolong a “grace period” during throttling. In some embodiments, however, the processor throttling (for example, the CPU throttling) may be faster than the frequency of the impedance peak. In this case, in some embodiments the protection may be implemented without the additional power source to prolong the “grace period” during throttling.

In some embodiments, real application consumption may be factored for a VID calculation using machine code (for example, pcode). A voltage gain savings of (I_{PV}-I_{App})*R_{LL} may occur, where I_{PV} is power virus current, I_{App} is application current, and R_{LL} is load line resistance. This may correspond, for example, to a voltage range between approximately 50 mV to approximately 150 mV of voltage savings, depending on the specific product and mother board voltage regulator (VR) characteristics. It can also reduce the guard band or even remove need for a guard band. This can help to reduce power consumption.

In some embodiments, to prevent processor overstress (for example, CPU, SoC, and/or processor core overstress), the on-die voltage monitor can include both a minimum and a maximum voltage threshold. In addition to a clamp to high voltage alternative power source, V_{SS} clamping may also be enabled. As a result, voltage on a package decoupling capacitance can stay within predefined bounds.

In some embodiments, a maximum voltage (Vmax) to minimum voltage (Vmin) gap may be reduced. This can enable setting a lower core voltage (VID) for a given frequency, and can enable higher performance. Further, in some embodiments, by maintaining an effective on-die voltage within predefined limits, reliability guard bands may be reduced, power consumption may be decreased, and performance may be improved.

FIG. 1 illustrates a block diagram of an example system 100 in accordance with some embodiments. System 100 includes a processor 102, a voltage regulator (VR) 104, and a surge protector 110. In some embodiments, processor 102 can be a central processing unit (CPU), a system on chip (SoC), and/or a processor core, for example. In some embodiments, voltage regulator 104 can be a motherboard voltage regulator (MBVR), for example.

Surge protector 110 can assert a throttle signal to the processor 102 when a core voltage, or input voltage (for example, voltage Vin), drops below a set threshold level (for example, voltage Vth). The throttle signal to the processor 102 can be used to make sure that the core voltage (or input voltage) Vin does not drop below a threshold voltage Vth.

In some embodiments, surge protector 110 includes an on-die dedicated circuit that monitors voltage Vin (for example, monitors voltage on package decoupling capacitors). In accordance with some embodiments, when this voltage (or its time derivative, or its time integral, or a combination of two or more of the voltage, its time derivative, and its time integral) crosses a pre-defined threshold (for example, crosses threshold voltage Vth), the throttle signal is sent to request throttling of the processor 102 in order to throttle the processor 102 to protect the input voltage Vin, and a path connecting the processor 102 to an alternative power source may be switched to low impedance, allowing additional current flow to the processor 102.

FIG. 2 illustrates a block diagram of an example system 200 in accordance with some embodiments. System 200 includes a processor 202, a voltage regulator (VR) 204, a capacitor 206 (for example, a package decoupling capacitor), a capacitor 208 (for example, a package decoupling capacitor), and a surge protector 210. In some embodiments, processor 202 can be a central processing unit (CPU), a system on chip (SoC), and/or a processor core, for example. In some embodiments, voltage regulator 204 can be a motherboard voltage regulator (MBVR), for example.

Surge protector 210 includes a comparator 212. Comparator 212 can assert a throttle signal to the processor 202 when a core voltage, or input voltage (for example, voltage Vin), drops below a set threshold level (for example, voltage Vth). The throttle signal to the processor 202 can be used to make sure that the core voltage (or input voltage) Vin does not drop below a threshold voltage Vth.

In some embodiments, surge protector 210 includes an on-die dedicated circuit that monitors voltage Vin (for example, monitors voltage on package decoupling capacitors). In accordance with some embodiments, when this voltage (or its time derivative, or its time integral, or a combination of two or more of the voltage, its time derivative, and its time integral) crosses a pre-defined threshold (for example, crosses threshold voltage Vth), the throttle signal is sent to request throttling of the processor 202 in order to throttle the processor 202 to protect the input voltage Vin, and a path connecting the processor 202 to an alternative power source may be switched to low impedance, allowing additional current flow to the processor 202.

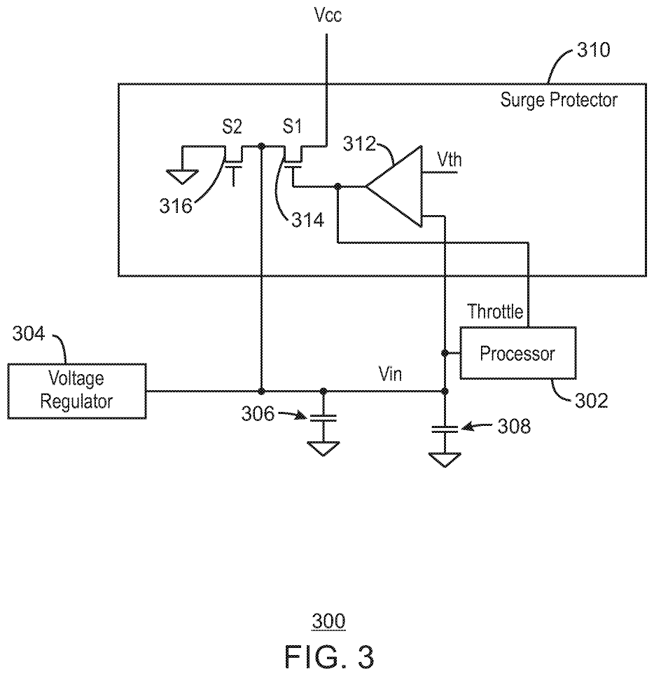

FIG. 3 illustrates a block diagram of an example system 300 in accordance with some embodiments. System 300 includes a processor 302, a voltage regulator (VR) 304, a capacitor 306 (for example, a package decoupling capacitor), a capacitor 308 (for example, a package decoupling capacitor), and a surge protector 310. In some embodiments, processor 302 can be a central processing unit (CPU), a system on chip (SoC), and/or a processor core, for example. In some embodiments, voltage regulator 304 can be a motherboard voltage regulator (MBVR), for example.

Surge protector 310 includes a comparator 312. Comparator 312 can assert a throttle signal to the processor 302 when a core voltage, or input voltage (for example, voltage Vin), drops below a set threshold level (for example, voltage Vth). The throttle signal to the processor 302 can be used to make sure that the core voltage (or input voltage) Vin does not drop below a threshold voltage Vth. In some embodiments, the input voltage (Vin) is maintained relative to the threshold voltage (Vth). For example, in some embodiments, the input voltage (Vin) is maintained at a level that is at the threshold voltage (Vth), slightly above the threshold voltage (Vth), or between the processor minimum voltage Vmin and the threshold voltage Vth. In some embodiments, the input voltage (Vin) may also (or instead) be maintained at the minimum process level, or between the level of the threshold voltage and the minimum processor voltage, for example.

Surge protector 310 includes comparator 312, some control circuitry, and in some embodiments at least one transistor 314 (for example, a field effect transistor and/or a switch S1) connected to a higher input voltage Vcc (for example, a supply voltage of 1.8V, 3.3V, etc.) Surge protector 310 can also include a second transistor 316 (for example, a field effect transistor and/or a switch S2) connected to a ground voltage, for example. When the core voltage Vin drops below a set threshold level (for example, voltage Vth), the comparator 312 asserts the throttle signal to the processor 302 and will start operating the transistor 314 (or switch S1) in order to regulate the voltage Vin above a minimum processor voltage (for example, Vmin). In some embodiments, transistors 314 and 316 (for example, switches S1 and S2) may be operated to control the voltage Vin in a hysteretic mode of operation. Transistor 316 (for example, switch S2) may be used in some embodiments to protect against a Vin overshoot. In some embodiments, only transistor 314 (for example, switch S1) is switched.

Transistors 314 and 316 (switches S1 and S2) are provided in system 300 for implementations of providing power in situations where throttling is not fast enough to maintain voltage Vin above a threshold voltage Vth (and/or above Vmin and/or above VID). In this manner, if throttling is not provided quickly, transistors 314 and 316 can provide power to supplement the main power source. However, in some embodiments, if throttling can be provided very quickly, transistors 314 and 316 (switches S1 and S2) may be unnecessary. For example, in such situations, system 200 may be used.

In some embodiments, surge protector 310 includes an on-die dedicated circuit that monitors voltage Vin (for example, monitors voltage on package decoupling capacitors). In accordance with some embodiments, when this voltage (or its time derivative, or its time integral, or a combination of two or more of the voltage, its time derivative, and its time integral) crosses a pre-defined threshold (for example, crosses threshold voltage Vth), the throttle signal is sent to request throttling of the processor 302 in order to throttle the processor 302 to protect the input voltage Vin, and a path connecting the processor 302 to an alternative power source (for example, a path including transistors 314 and/or 316) is switched to low impedance, allowing additional current flow to the processor 302.

Some embodiments allow a lowering of the VID voltage (for example, voltage identification and/or core voltage), since the processor can be protected against an under-voltage droop (for example, in cases of virus currents, motherboard voltage regulator deficiency such as in situations where all controller inaccuracies occur simultaneously on the motherboard, and the processor drawing current at an exact peak impedance such as load line or LL2, etc.)

In some embodiments, since voltage threshold protection is implemented, the VID may be set to a lower value than it might otherwise be set. Since power consumed by the processor is proportional to voltage squared (v²), less power consumption is possible when setting the VID to a lower level. This can allow a higher frequency setting.

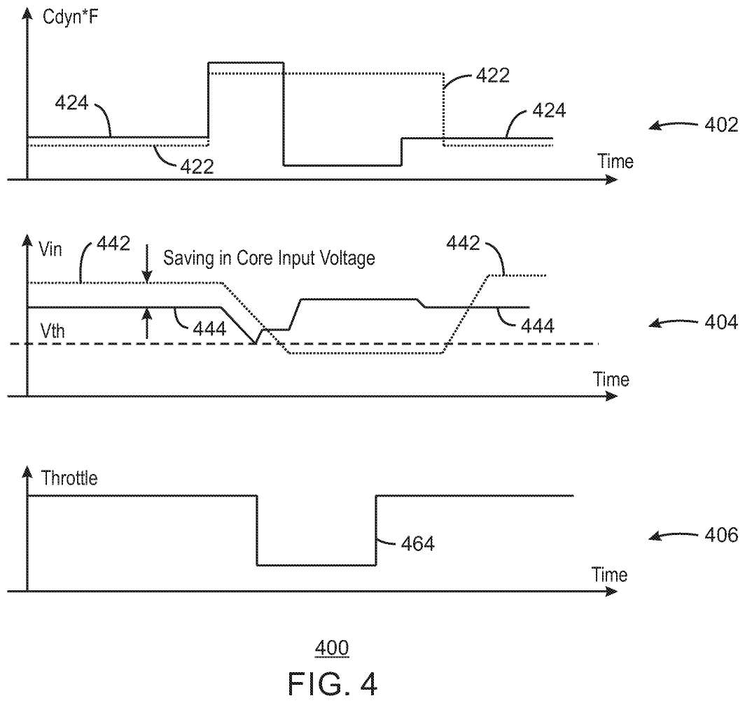

FIG. 4 illustrates waveforms 400 in accordance with some embodiments. Waveforms 400 can include, for example, dynamic capacitance times frequency (Cdyn*F) waveforms 402, input voltage (Vin) waveforms 404, and throttle signal waveform 406. Waveforms 400 can be used to illustrate how processor throttling can be used in accordance with some embodiments to make sure that input voltage Vin does not decrease lower than a threshold voltage Vth or a processor minimum voltage Vmin.

Waveforms 402 include waveform (Cdyn*F) 422 of an example implementation that does not use threshold voltage protection and waveform (Cdyn*F) 424 of an example implementation that does use threshold voltage protection. For example, waveform 424 can illustrate an implementation in accordance with some embodiments such as implemented by system 300 of FIG. 3. It is noted that total power consumed by the processor can be proportional to Cdyn*F, so power consumed by the processor can increase and decrease in a manner similar to waveforms 402.

Waveforms 404 include waveform (Vin) 442 of an example implementation that does not use threshold voltage protection and waveform (Vin) 444 of an example implementation that does use threshold voltage protection. For example, waveform 444 can illustrate an implementation in accordance with some embodiments such as implemented by system 300 of FIG. 3.

Waveform 406 includes a waveform (Throttle) 464 (for example, of an example implementation that does use threshold voltage protection such as the Throttle signal illustrated in system 300 of FIG. 3).

Waveforms 422 and 442 illustrate waveforms relating to systems that do not use threshold voltage protection to protect the input voltage Vin. The VID (for example, the motherboard VID) may be set high enough that even with the worst processor perturbation, the processor voltage will be above a minimum level. Waveforms 422 and 442 illustrate that if the processor activity increases, and the processor begins to consume more power, the processor input voltage Vin droops until it reaches some value. When the processor then reduces its activity, the power drops and the voltage Vin recovers.

Waveforms 424 and 444 illustrate waveforms relating to systems that do use threshold voltage protection to protect the input voltage Vin in accordance with some embodiments. For example, waveforms 424 and 444 can illustrate waveforms relating to system 300 of FIG. 3 using surge protector 310. In some embodiments, VID (for example, the motherboard VID) may be set lower, and due to the lower voltage the processor power consumption can be lower and the actual processor frequency can be higher. When processor usage spikes due to a higher application ratio, the processor starts to consume more power, and the processor input voltage (Vin) may start to droop. However, in accordance with some embodiments, a drooping of the input voltage (Vin) below a threshold level (Vth) may be detected (for example, using a surge protector such as surge protector 310). When it is detected that the input voltage (Vin) has drooped below the threshold level (Vth), a throttle signal (Throttle) may be sent to command the processor to throttle, and power may be provided to maintain the processor input voltage (Vin) slightly above the threshold value (Vth), as illustrated by waveforms 424, 444, and 464, for example. Although not necessarily illustrated in FIG. 4, in some embodiments, the input voltage (Vin) may also (or instead) be maintained at the minimum process level, or between the level of the threshold voltage and the minimum processor voltage, for example.

In some embodiments, as illustrated by the waveforms in FIG. 4, for example, frequency F may be increased, and performance may be improved, since there can be less concern about the voltage drooping below the threshold voltage once throttling of the processor is implemented. This is illustrated in FIG. 4, for example, by portions of waveform 424 that are higher than corresponding portions of waveform 422 in FIG. 4. Therefore, in some embodiments, since voltage threshold protection is implemented, the VID may be set to a lower value than it might otherwise be set. Since power consumed by the processor is proportional to voltage squared (v²), less power consumption is possible when setting the VID to a lower level. This can allow a higher frequency setting.

Many different embodiments may be implemented to control input voltage (Vin) at this level (for example, slightly above a threshold voltage Vth, at a minimum process level, and/or between the level of the threshold voltage and the minimum processor voltage). In accordance with some embodiments, for example, one or more of the following may be implemented, among others:

Hysteretic control of a switch such as switch S1, with potentially also using a switch S2 to overcome an overshoot;

An array of switches with high resistance (in place of S1 or in addition to S1), and a controller to turn some or all of the switches on and/or off in order to maintain the voltage at a level that is slightly above the threshold level (in some embodiments, the voltage may also or instead be maintained at the minimum process level, or between the level of the threshold voltage and the minimum processor voltage, for example);

Using a linear regulator (in place of S1 or in addition to S1), with its resistance directly controller by a controller to maintain a Vccin voltage; and/or

Using a switching voltage regulator (in place of S1 or in addition to S1), with known and/or pre-defined parasitic inductance in series (for example, an analog of a traditional buck converter).

In some embodiments, throttling may be set for a particular time duration, and/or throttling may be de-asserted after a given delay. In some embodiments the voltage regulator may be turned off either after the delay time expires, and/or because the voltage crossed an upper bound. In some embodiments, a duration of the delay may be based on a delay of a throttling function (for example, based on how long it takes to throttle the processor, CPU, SoC, and/or core, etc.)

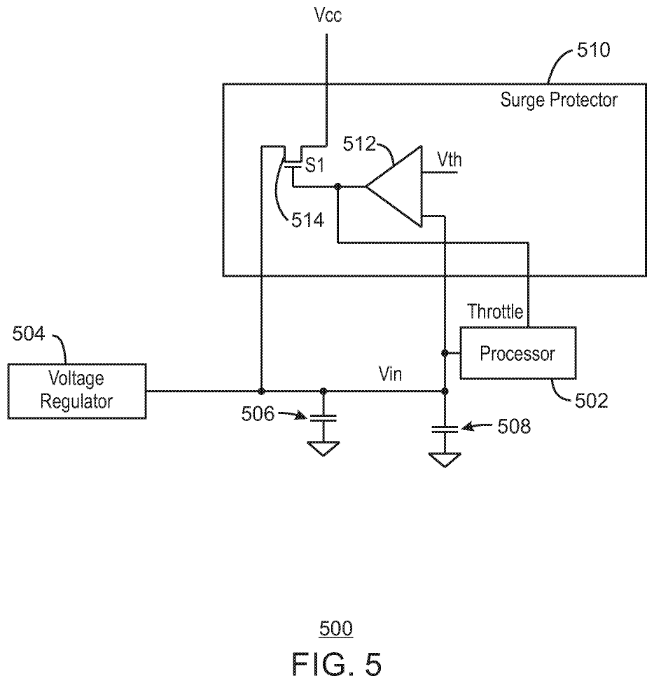

FIG. 5 illustrates a block diagram of an example system 500 in accordance with some embodiments. In some embodiments, system 500 can be similar to or the same as system 300, with transistor 316 (switch S2) removed from the system. System 500 includes a processor 502, a voltage regulator (VR) 504, a capacitor 506 (for example, a package decoupling capacitor), a capacitor 508 (for example, a package decoupling capacitor), and a surge protector 510. In some embodiments, processor 502 can be a central processing unit (CPU), a system on chip (SoC), and/or a processor core, for example. In some embodiments, voltage regulator 504 can be a motherboard voltage regulator (MBVR), for example.

Surge protector 510 includes a comparator 512. Comparator 512 can assert a throttle signal to the processor 502 when a core voltage, or input voltage (for example, voltage Vin), drops below a set threshold level (for example, voltage Vth). The throttle signal to the processor 502 can be used to make sure that the core voltage (or input voltage) Vin does not drop below a threshold voltage Vth. In some embodiments, the input voltage (Vin) is maintained relative to the threshold voltage (Vth). For example, in some embodiments, the input voltage (Vin) is maintained at a level that is at the threshold voltage (Vth), slightly above the threshold voltage (Vth), or between the processor minimum voltage Vmin and the threshold voltage Vth. In some embodiments, the input voltage (Vin) may also (or instead) be maintained at the minimum process level, or between the level of the threshold voltage and the minimum processor voltage, for example.

Surge protector 510 includes comparator 512, some control circuitry, and a transistor 514 (for example, a field effect transistor and/or a switch S1) connected to a higher input voltage Vcc (for example, a supply voltage of 1.8V, 3.3V, etc.) When the core voltage Vin drops below a set threshold level (for example, voltage Vth), the comparator 512 asserts the throttle signal to the processor 502 and will start operating the transistor 514 (or switch S1) in order to regulate the voltage Vin above a minimum processor voltage (for example, Vmin).

In some embodiments, surge protector 510 includes an on-die dedicated circuit that monitors voltage Vin (for example, monitors voltage on package decoupling capacitors). In accordance with some embodiments, when this voltage (or its time derivative, or its time integral, or a combination of two or more of the voltage, its time derivative, and its time integral) crosses a pre-defined threshold (for example, crosses threshold voltage Vth), the throttle signal is sent to request throttling of the processor 502 in order to throttle the processor 502 to protect the input voltage Vin, and a path connecting the processor 502 to an alternative power source (for example, a path including transistor 514) is switched to low impedance, allowing additional current flow to the processor 502.

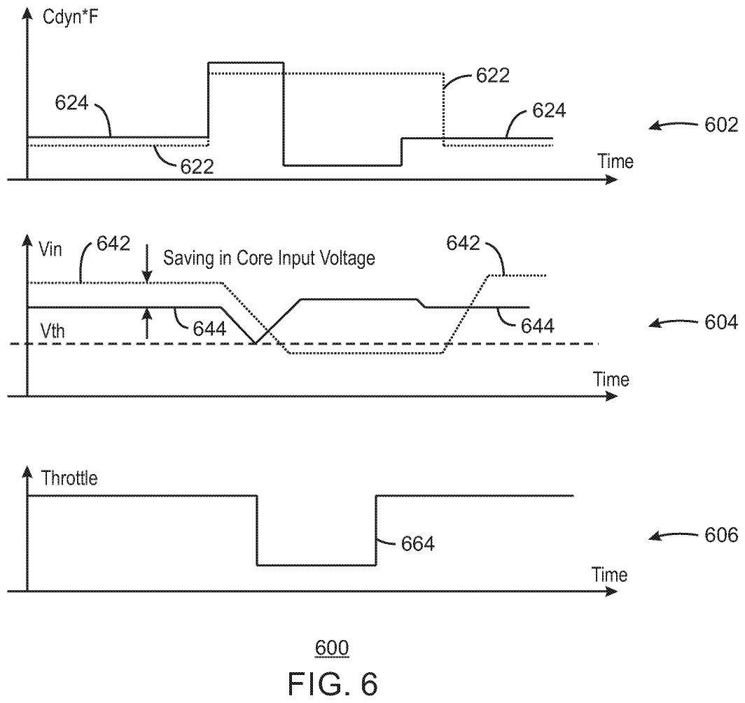

FIG. 6 illustrates waveforms 600 in accordance with some embodiments. Waveforms 600 can include, for example, dynamic capacitance times frequency (Cdyn*F) waveforms 602, input voltage (Vin) waveforms 604, and throttle signal waveform 606. Waveforms 600 can be used to illustrate how processor throttling can be used in accordance with some embodiments to make sure that input voltage Vin does not decrease lower than a threshold voltage Vth.

Waveforms 602 include waveform (Cdyn*F) 622 of an example implementation that does not use threshold voltage protection and waveform (Cdyn*F) 624 of an example implementation that does use threshold voltage protection. For example, waveform 624 can illustrate an implementation in accordance with some embodiments such as implemented by system 500 of FIG. 5. It is noted that total power consumed by the processor can be proportional to Cdyn*F, so power consumed by the processor can increase and decrease in a manner similar to waveforms 602.

Waveforms 606 include waveform (Vin) 642 of an example implementation that does not use threshold voltage protection and waveform (Vin) 644 of an example implementation that does use threshold voltage protection. For example, waveform 644 can illustrate an implementation in accordance with some embodiments such as implemented by system 500 of FIG. 5.

Waveform 606 includes a waveform (Throttle) 664 (for example, of an example implementation that does use threshold voltage protection such as the Throttle signal illustrated in system 500 of FIG. 5).

Waveforms 622 and 642 illustrate waveforms relating to systems that do not use threshold voltage protection to protect the input voltage Vin. The VID (for example, the motherboard VID) may be set high enough that even with the worst processor perturbation, the processor voltage will be above a minimum level. Waveforms 622 and 642 illustrate that if the processor activity increases, and the processor begins to consume more power, the processor input voltage Vin droops until it reaches some value. When the processor then reduces it's activity, the power drops and the voltage Vin recovers.

Waveforms 624 and 644 illustrate waveforms relating to systems that do use threshold voltage protection to protect the input voltage Vin in accordance with some embodiments. For example, waveforms 624 and 644 can illustrate waveforms relating to system 500 of FIG. 5 using surge protector 510. In some embodiments, VID (for example, the motherboard VID) may be set lower, and due to the lower voltage the processor power consumption can be lower and the actual processor frequency can be higher. When processor usage spikes due to a higher application ratio, the processor starts to consume more power, and the processor input voltage (Vin) may start to droop. However, in accordance with some embodiments, a drooping of the input voltage (Vin) below a threshold level (Vth) may be detected (for example, using a surge protector such as surge protector 510). When it is detected that the input voltage (Vin) has drooped below the threshold level (Vth), a throttle signal (Throttle) may be sent to command the processor to throttle, and power may be provided to maintain the processor input voltage (Vin) slightly above the threshold value (Vth), as illustrated by waveforms 624, 644, and 664, for example. Although not necessarily illustrated in FIG. 6, in some embodiments, the input voltage (Vin) may also (or instead) be maintained at the minimum process level, or between the level of the threshold voltage and the minimum processor voltage, for example.

In some embodiments, as illustrated by the waveforms in FIG. 6, for example, frequency F may be increased, and performance may be improved, since there can be less concern about the voltage drooping below the threshold voltage once throttling of the processor is implemented. This is illustrated in FIG. 6, for example, by portions of waveform 624 that are higher than corresponding portions of waveform 622 in FIG. 6. Therefore, in some embodiments, since voltage threshold protection is implemented, the VID may be set to a lower value than it might otherwise be set. Since power consumed by the processor is proportional to voltage squared (v²), less power consumption is possible when setting the VID to a lower level. This can allow a higher frequency setting.

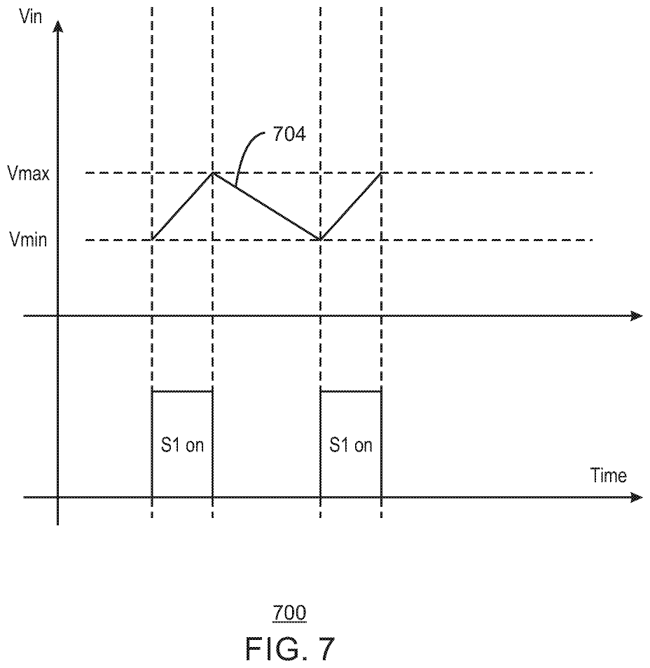

FIG. 7 illustrates a timing diagram 700 in accordance with some embodiments. In some embodiments, timing diagram 700 includes a waveform 704 illustrating an input voltage Vin over time. For example, in some embodiments, waveform 704 relates to a system such as system 500 of FIG. 5 in which threshold voltage protection may be implemented (for example, by throttling a processor to protect the input voltage such as Vin, and/or maintain it relative to a threshold voltage such as Vth). As illustrated in FIG. 7, when a switch S1 (for example, such as transistor 514) is on, input voltage Vin increases from a minimum voltage Vmin to a maximum voltage Vmax. Similarly, as illustrated in FIG. 7, when a switch S2 (for example, such as transistor 514) is off, input voltage Vin decreases from maximum voltage Vmax to minimum voltage Vmin.

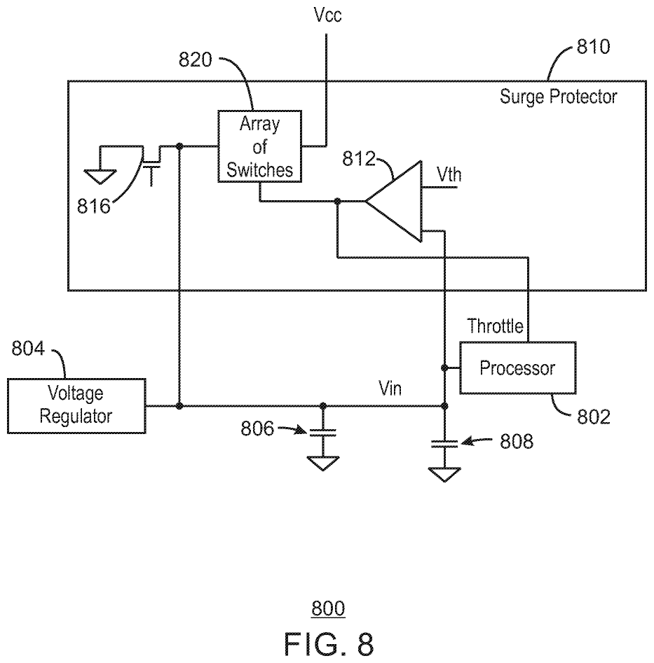

FIG. 8 illustrates a block diagram of an example system 800 in accordance with some embodiments. System 800 includes a processor 802, a voltage regulator (VR) 804, a capacitor 806 (for example, a package decoupling capacitor), a capacitor 808 (for example, a package decoupling capacitor), and a surge protector 810. In some embodiments, processor 802 can be a central processing unit (CPU), a system on chip (SoC), and/or a processor core, for example. In some embodiments, voltage regulator 804 can be a motherboard voltage regulator (MBVR), for example.

Surge protector 810 includes a comparator 812. Comparator 812 can assert a throttle signal to the processor 802 when a core voltage, or input voltage (for example, voltage Vin), drops below a set threshold level (for example, voltage Vth). The throttle signal to the processor 802 can be used to make sure that the core voltage (or input voltage) Vin does not drop below a threshold voltage Vth.

Surge protector 810 includes comparator 812, some control circuitry, and at least one transistor (for example, a field effect transistor and/or a switch) connected to a higher input voltage Vcc (for example, a supply voltage of 1.8V, 3.3V, etc.) Surge protector 810 can include comparator 810, transistor 816, and an array of switches 820 (for example, an array of transistors, and/or an array of field effect transistors). In some embodiments, system 800 is similar to or the same as system 300 of FIG. 3, with the array of switches 820 substituted for (or in addition to) transistor 314 (switch S1). In some embodiments, array of switches 820 are an array of switches with high resistance. In some embodiments, the input voltage (Vin) is maintained relative to the threshold voltage (Vth). For example, in some embodiments, the input voltage (Vin) is maintained at a level that is at the threshold voltage (Vth), slightly above the threshold voltage (Vth), or between the processor minimum voltage Vmin and the threshold voltage Vth. In some embodiments, the input voltage (Vin) may also (or instead) be maintained at the minimum process level, or between the level of the threshold voltage and the minimum processor voltage, for example. In some embodiments, a controller can turn some of the switches in array 820 on and/or off to maintain input voltage Vin relative to threshold voltage Vth (for example, at the threshold voltage Vth, slightly above the threshold voltage Vth, between the processor minimum voltage Vmin and the threshold voltage Vth, or at some other voltage level).

Second transistor 816 (for example, a field effect transistor and/or a switch S2) is connected to a ground voltage, for example. When the core voltage Vin drops below a set threshold level (for example, voltage Vth), the comparator 812 asserts the throttle signal to the processor 802 and will start operating the array of switches 820 in order to regulate the voltage Vin at or above a minimum processor voltage (for example, Vmin). In some embodiments, transistor 816 and the array of switches 820 may be operated to control the voltage Vin in a hysteretic mode of operation. Transistor 816 may be used in some embodiments to protect against a Vin overshoot. In some embodiments, only switches in the array of switches 820 are switched, and transistor 816 is not switched.

In some embodiments, surge protector 810 includes an on-die dedicated circuit that monitors voltage Vin (for example, monitors voltage on package decoupling capacitors). In accordance with some embodiments, when this voltage (or its time derivative, or its time integral, or a combination of two or more of the voltage, its time derivative, and its time integral) crosses a pre-defined threshold (for example, crosses threshold voltage Vth), the throttle signal is sent to request throttling of the processor 802 in order to throttle the processor 802 to protect the input voltage Vin, and a path connecting the processor 802 to an alternative power source (for example, a path including array of switches 820 and/or transistor 816) is switched to low impedance, allowing additional current flow to the processor 802.

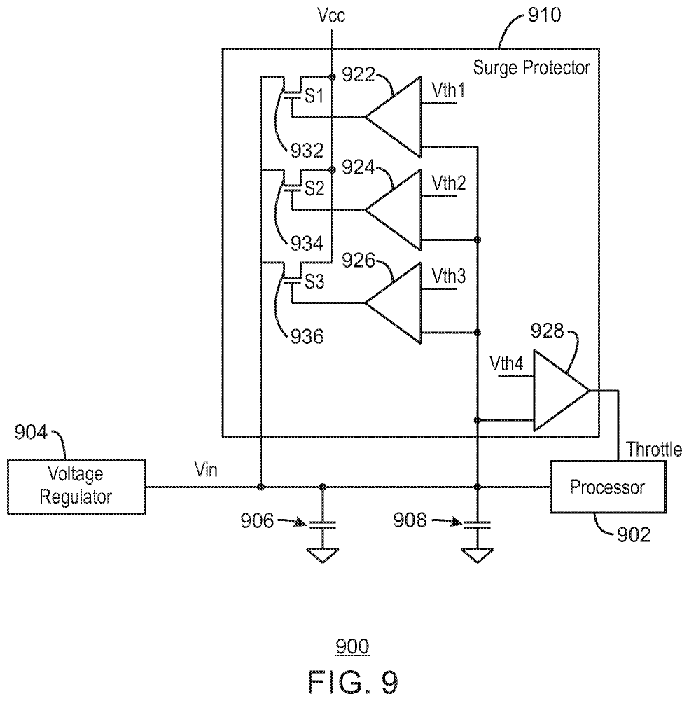

FIG. 9 illustrates a block diagram of an example system 900 in accordance with some embodiments. System 900 includes a processor 902, a voltage regulator (VR) 904, a capacitor 906 (for example, a package decoupling capacitor), a capacitor 908 (for example, a package decoupling capacitor), and a surge protector 910. In some embodiments, processor 902 can be a central processing unit (CPU), a system on chip (SoC), and/or a processor core, for example. In some embodiments, voltage regulator 904 can be a motherboard voltage regulator (MBVR), for example.

Surge protector 910 includes comparators 922, 924, 926 and 928. Comparator 928 can assert a throttle signal to the processor 902 when a core voltage, or input voltage (for example, voltage Vin), drops below a set threshold level (for example, voltage Vth4). The throttle signal to the processor 902 can be used to make sure that the core voltage (or input voltage) Vin does not drop below a threshold voltage Vth4.

Surge protector 910 includes comparators 922, 924, 926, and 928, some control circuitry, and an array of transistors 932, 934, and 936 (for example, an array of field effect transistors 932, 934, 936 and/or an array of switches 932, 934, 936). Any number of transistors 932, 934, and 936 and any number of comparators 922, 924, 926, and 928 may be used in accordance with some embodiments. Transistors 932, 934, and 936 are connected to a higher input voltage Vcc (for example, a supply voltage of 1.8V, 3.3V, etc.) Surge protector 910 can include an array of comparators and an array of switches (for example, an array of transistors, and/or an array of field effect transistors). In some embodiments, system 900 is similar to or the same as system 300 of FIG. 3, system 500 of FIG. 5, and/or system 800 of FIG. 8. In some embodiments, the array of switches 932, 934, 936 are an array of switches with high resistance. In some embodiments, the input voltage (Vin) is maintained relative to a threshold voltage (Vth1, Vth2, Vth3, and/or Vth4). For example, in some embodiments, the input voltage (Vin) is maintained at a level that is slightly above a threshold voltage (Vth1, Vth2, Vth3, and/or Vth4). In some embodiments, the input voltage (Vin) may also (or instead) be maintained at the minimum process level, or between the level of the threshold voltage and the minimum processor voltage, for example. In some embodiments, a controller can turn some of the switches 932, 934, 936 in the array on and/or off to maintain input voltage Vin relative to one or more threshold voltage Vth (for example, at slightly above one or more threshold voltage, or at some other voltage level).

When the core voltage Vin drops below a set threshold level (for example, voltage Vth1, Vth2, Vth3, and/or Vth4, and/or a combination of those voltages), the comparator 928 asserts the throttle signal to the processor 902 and will start operating the array of switches 932, 934, 936 and/or the comparators 922, 924, 926 in order to regulate the voltage Vin at or above a minimum processor voltage (for example, Vmin). In some embodiments, the array of switches may be operated to control the voltage Vin in a hysteretic mode of operation. One or more of the transistors may be used in some embodiments to protect against a Vin overshoot. In some embodiments, only some switches in the array of switches are switched, and others are not switched.

In some embodiments, surge protector 910 includes an on-die dedicated circuit that monitors voltage Vin (for example, monitors voltage on package decoupling capacitors). In accordance with some embodiments, when this voltage (or its time derivative, or its time integral, or a combination of two or more of the voltage, its time derivative, and its time integral) crosses a pre-defined threshold (for example, crosses threshold voltage Vth1, Vth2, Vth3, Vth4, and/or some combination thereof), the throttle signal is sent to request throttling of the processor 902 in order to throttle the processor 902 to protect the input voltage Vin, and a path connecting the processor 902 to an alternative power source (for example, a path including one or more of the array of switches) is switched to low impedance, allowing additional current flow to the processor 902.

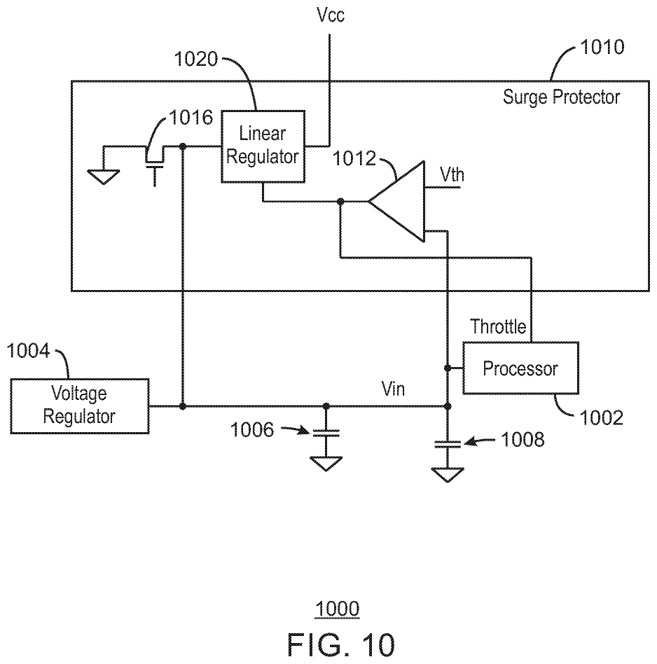

FIG. 10 illustrates a block diagram of an example system 1000 in accordance with some embodiments. System 1000 includes a processor 1002, a voltage regulator (VR) 1004, a capacitor 1006 (for example, a package decoupling capacitor), a capacitor 1008 (for example, a package decoupling capacitor), and a surge protector 1010. In some embodiments, processor 1002 can be a central processing unit (CPU), a system on chip (SoC), and/or a processor core, for example. In some embodiments, voltage regulator 1004 can be a motherboard voltage regulator (MBVR), for example.

Surge protector 1010 includes a comparator 1012. Comparator 1012 can assert a throttle signal to the processor 1002 when a core voltage, or input voltage (for example, voltage Vin), drops below a set threshold level (for example, voltage Vth). The throttle signal to the processor 1002 can be used to make sure that the core voltage (or input voltage) Vin does not drop below a threshold voltage Vth.

Surge protector 1010 includes comparator 1012 and some control circuitry. Surge protector 1010 can also include a linear regulator 1020 and/or at least one transistor (for example, a field effect transistor and/or a switch) connected to a higher input voltage Vcc (for example, a supply voltage of 1.8V, 3.3V, etc.) Surge protector 1010 can include comparator 1012, transistor 1016, and the linear regulator 1020. In some embodiments, system 1000 is similar to or the same as system 300 of FIG. 3, with the linear regulator 1020 substituted for (or in addition to) transistor 314 (switch S1). In some embodiments, linear regulator 1020 has its resistance directly controlled by a controller to maintain a Vccin voltage. In some embodiments, the input voltage (Vin) is maintained relative to the threshold voltage (Vth). For example, in some embodiments, the input voltage (Vin) is maintained at a level that is at the threshold voltage (Vth), slightly above the threshold voltage (Vth), or between the processor minimum voltage Vmin and the threshold voltage Vth. In some embodiments, the input voltage (Vin) may also (or instead) be maintained at the minimum process level, or between the level of the threshold voltage and the minimum processor voltage, for example. In some embodiments, a controller can control linear regulator 1020 to maintain input voltage Vin relative to threshold voltage Vth (for example, at the threshold voltage Vth, slightly above the threshold voltage Vth, between the processor minimum voltage Vmin and the threshold voltage Vth, or at some other voltage level).

Second transistor 1016 (for example, a field effect transistor and/or a switch S2) is connected to a ground voltage, for example. When the core voltage Vin drops below a set threshold level (for example, voltage Vth), the comparator 1012 asserts the throttle signal to the processor 1002 and will start operating the linear regulator 1020 in order to regulate the voltage Vin above a minimum processor voltage (for example, Vmin). In some embodiments, transistor 1016 and the linear regulator 1020 may be operated to control the voltage Vin in a hysteretic mode of operation. Transistor 1016 may be used in some embodiments to protect against a Vin overshoot. In some embodiments, transistor 1016 is not switched.

In some embodiments, surge protector 1010 includes an on-die dedicated circuit that monitors voltage Vin (for example, monitors voltage on package decoupling capacitors). In accordance with some embodiments, when this voltage (or its time derivative, or its time integral, or a combination of two or more of the voltage, its time derivative, and its time integral) crosses a pre-defined threshold (for example, crosses threshold voltage Vth), the throttle signal is sent to request throttling of the processor 1002 in order to throttle the processor 1002 to protect the input voltage Vin, and a path connecting the processor 1002 to an alternative power source (for example, a path including linear regulator 1020 and/or transistor 1016) is switched to low impedance, allowing additional current flow to the processor 1002.

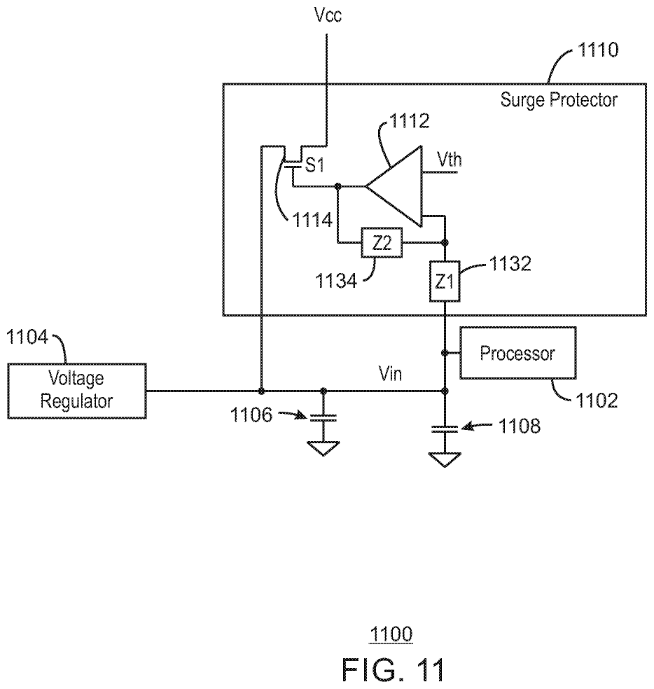

FIG. 11 illustrates a block diagram of an example system 1100 in accordance with some embodiments. System 1100 includes a processor 1102, a voltage regulator (VR) 1104, a capacitor 1106 (for example, a package decoupling capacitor), a capacitor 1108 (for example, a package decoupling capacitor), and a surge protector 1110. In some embodiments, processor 1102 can be a central processing unit (CPU), a system on chip (SoC), and/or a processor core, for example. In some embodiments, voltage regulator 1104 can be a motherboard voltage regulator (MBVR), for example.

Surge protector 1110 includes a comparator 1112. Comparator 1112 can assert a throttle signal to the processor 1102 when a core voltage, or input voltage (for example, voltage Vin), drops below a set threshold level (for example, voltage Vth). The throttle signal to the processor 1102 can be used to make sure that the core voltage (or input voltage) Vin does not drop below a threshold voltage Vth.

Surge protector 1110 includes comparator 1112 and some control circuitry. Surge protector 1110 includes impedances 1132 (Z1) and 1134 (Z2). Surge protector 1110 can also include a linear regulator and/or at least one transistor 1114 (for example, a field effect transistor and/or a switch) connected to a higher input voltage Vcc (for example, a supply voltage of 1.8V, 3.3V, etc.) Surge protector 1110 can include comparator 1112, transistor 1114, and the linear regulator. In some embodiments, transistor 1114 (switch S1) may be used as the linear regulator. In some embodiments, system 1100 is similar to or the same as system 300 of FIG. 3, with the linear regulator substituted for (or in addition to) transistor 314 (switch S1). In some embodiments, the linear regulator has its resistance directly controlled by a controller to maintain a Vccin voltage. In some embodiments, the input voltage (Vin) is maintained relative to the threshold voltage (Vth). For example, in some embodiments, the input voltage (Vin) is maintained at a level that is at the threshold voltage (Vth), slightly above the threshold voltage (Vth), or between the processor minimum voltage Vmin and the threshold voltage Vth. In some embodiments, the input voltage (Vin) may also (or instead) be maintained at the minimum process level, or between the level of the threshold voltage and the minimum processor voltage, for example. In some embodiments, a controller can control the linear regulator to maintain input voltage Vin relative to threshold voltage Vth (for example, at the threshold voltage Vth, slightly above the threshold voltage Vth, between the processor minimum voltage Vmin and the threshold voltage Vth, or at some other voltage level).

Second transistor 1114 (for example, a field effect transistor and/or a switch S1) is connected to a ground voltage, for example. When the core voltage Vin drops below a set threshold level (for example, voltage Vth), the comparator 1112 asserts the throttle signal to the processor 1102 and will start operating the linear regulator in order to regulate the voltage Vin above a minimum processor voltage (for example, Vmin). In some embodiments, transistor 1114 and the linear regulator may be operated to control the voltage Vin. Transistor 1114 may be used in some embodiments to protect against a Vin overshoot. In some embodiments, transistor 1114 is not switched.

In some embodiments, surge protector 1110 includes an on-die dedicated circuit that monitors voltage Vin (for example, monitors voltage on package decoupling capacitors). In accordance with some embodiments, when this voltage (or its time derivative, or its time integral, or a combination of two or more of the voltage, its time derivative, and its time integral) crosses a pre-defined threshold (for example, crosses threshold voltage Vth), the throttle signal is sent to request throttling of the processor 1102 in order to throttle the processor 1102 to protect the input voltage Vin, and a path connecting the processor 1102 to an alternative power source (for example, a path including linear regulator and/or transistor 1114) is switched to low impedance, allowing additional current flow to the processor 1102.

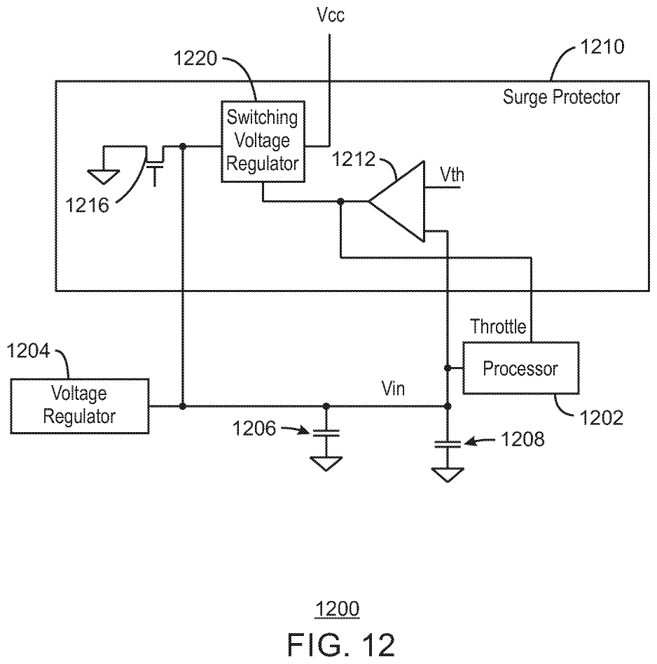

FIG. 12 illustrates a block diagram of an example system 1200 in accordance with some embodiments. System 1200 includes a processor 1202, a voltage regulator (VR) 1204, a capacitor 1206 (for example, a package decoupling capacitor), a capacitor 1208 (for example, a package decoupling capacitor), and a surge protector 1210. In some embodiments, processor 1202 can be a central processing unit (CPU), a system on chip (SoC), and/or a processor core, for example. In some embodiments, voltage regulator 1204 can be a motherboard voltage regulator (MBVR), for example.

Surge protector 1210 includes a comparator 1212. Comparator 1212 can assert a throttle signal to the processor 1202 when a core voltage, or input voltage (for example, voltage Vin), drops below a set threshold level (for example, voltage Vth). The throttle signal to the processor 1202 can be used to make sure that the core voltage (or input voltage) Vin does not drop below a threshold voltage Vth.

Surge protector 1210 includes comparator 1212 and some control circuitry. Surge protector 1210 can also include a switching voltage regulator 1220 and/or at least one transistor (for example, a field effect transistor and/or a switch) connected to a higher input voltage Vcc (for example, a supply voltage of 1.8V, 3.3V, etc.) Surge protector 1210 can include comparator 1212, transistor 1216, and the switching voltage regulator 1220. In some embodiments, system 1200 is similar to or the same as system 300 of FIG. 3, with the switching voltage regulator 1220 substituted for (or in addition to) transistor 314 (switch S1). In some embodiments, switching voltage regulator 1220 may be a switching voltage regulator with known and/or predefined parasitic inductance in series (for example, an analog of a traditional buck converter). In some embodiments, the input voltage (Vin) is maintained relative to the threshold voltage (Vth). For example, in some embodiments, the input voltage (Vin) is maintained at a level that is at the threshold voltage (Vth), slightly above the threshold voltage (Vth), or between the processor minimum voltage Vmin and the threshold voltage Vth. In some embodiments, the input voltage (Vin) may also (or instead) be maintained at the minimum process level, or between the level of the threshold voltage and the minimum processor voltage, for example. In some embodiments, a controller can control switching voltage regulator 1220 to maintain input voltage Vin relative to threshold voltage Vth (for example, at the threshold voltage Vth, slightly above the threshold voltage Vth, between the processor minimum voltage Vmin and the threshold voltage Vth, or at some other voltage level).

Second transistor 1216 (for example, a field effect transistor and/or a switch S2) is connected to a ground voltage, for example. When the core voltage Vin drops below a set threshold level (for example, voltage Vth), the comparator 1212 asserts the throttle signal to the processor 1202 and will start operating the switching voltage regulator 1220 in order to regulate the voltage Vin above a minimum processor voltage (for example, Vmin). In some embodiments, transistor 1216 and the switching voltage regulator 1220 may be operated to control the voltage Vin in a hysteretic mode of operation. Transistor 1216 may be used in some embodiments to protect against a Vin overshoot. In some embodiments, transistor 1216 is not switched.

In some embodiments, surge protector 1210 includes an on-die dedicated circuit that monitors voltage Vin (for example, monitors voltage on package decoupling capacitors). In accordance with some embodiments, when this voltage (or its time derivative, or its time integral, or a combination of two or more of the voltage, its time derivative, and its time integral) crosses a pre-defined threshold (for example, crosses threshold voltage Vth), the throttle signal is sent to request throttling of the processor 1202 in order to throttle the processor 1202 to protect the input voltage Vin, and a path connecting the processor 1202 to an alternative power source (for example, a path including switching voltage regulator 1220 and/or transistor 1216) is switched to low impedance, allowing additional current flow to the processor 1202.

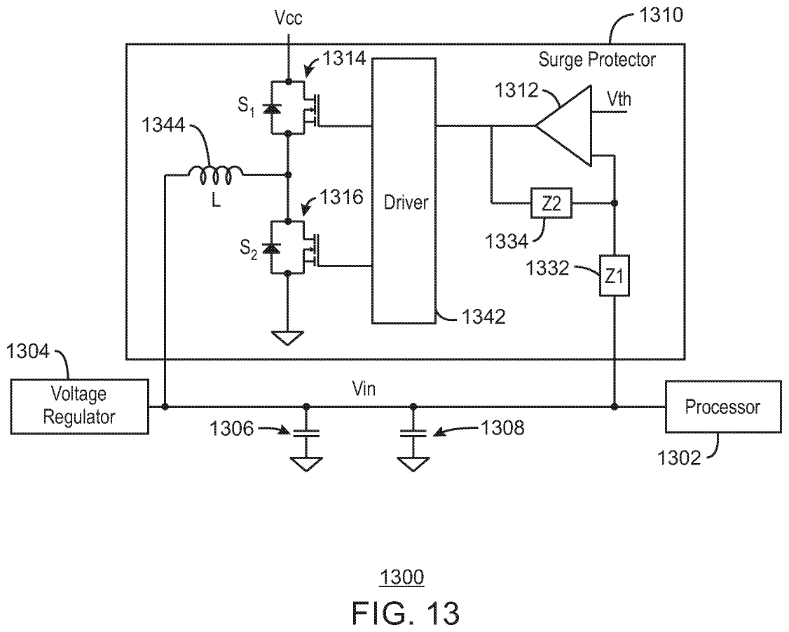

FIG. 13 illustrates a block diagram of an example system 1300 in accordance with some embodiments. System 1300 includes a processor 1302, a voltage regulator (VR) 1304, a capacitor 1306 (for example, a package decoupling capacitor), a capacitor 1308 (for example, a package decoupling capacitor), and a surge protector 1310. In some embodiments, processor 1302 can be a central processing unit (CPU), a system on chip (SoC), and/or a processor core, for example. In some embodiments, voltage regulator 1304 can be a motherboard voltage regulator (MBVR), for example.

Surge protector 1310 includes a comparator 1312. Comparator 1312 can assert a throttle signal to the processor 1302 when a core voltage, or input voltage (for example, voltage Vin), drops below a set threshold level (for example, voltage Vth). The throttle signal to the processor 1302 can be used to make sure that the core voltage (or input voltage) Vin does not drop below a threshold voltage Vth.

Surge protector 1310 includes comparator 1312 and some control circuitry. Surge protector 1310 can also include a buck converter (for example, a buck converter replacing switch S1 of FIG. 3). The buck converter may include a switch 1314, a switch 1316, and an inductor 1344. In some embodiments, surge protector 1310 can include a driver 1342 to drive the buck converter. In some embodiments, the buck converter may be a switching voltage regulator. In some embodiments, the buck converter may be a switching voltage regulator with known and/or predefined parasitic inductance in series.

In some embodiments, switch 1314 (S1) may be connected to a higher input voltage Vcc (for example, a supply voltage of 1.8V, 3.3V, etc.) Surge protector 1310 can include comparator 1312, transistors 1314 and 1316, a switching voltage regulator, and/or a buck converter. In some embodiments, system 1300 is similar to or the same as system 300 of FIG. 3, with the buck converter and/or switching voltage regulator substituted for (or in addition to) transistor 314 (switch S1). In some embodiments, the buck converter and/or the switching voltage regulator may be a switching voltage regulator with known and/or predefined parasitic inductance in series (for example, an analog of a traditional buck converter). In some embodiments, the input voltage (Vin) is maintained relative to the threshold voltage (Vth). For example, in some embodiments, the input voltage (Vin) is maintained at a level that is at the threshold voltage (Vth), slightly above the threshold voltage (Vth), or between the processor minimum voltage Vmin and the threshold voltage Vth. In some embodiments, the input voltage (Vin) may also (or instead) be maintained at the minimum process level, or between the level of the threshold voltage and the minimum processor voltage, for example. In some embodiments, a controller can control the buck converter and/or switching voltage regulator to maintain input voltage Vin relative to threshold voltage Vth (for example, at the threshold voltage Vth, slightly above the threshold voltage Vth, between the processor minimum voltage Vmin and the threshold voltage Vth, or at some other voltage level).

Second transistor 1316 (for example, a field effect transistor and/or a switch S2) is connected to a ground voltage, for example. When the core voltage Vin drops below a set threshold level (for example, voltage Vth), the comparator 1312 asserts the throttle signal to the processor 1302 and will start operating the switching voltage regulator and/or buck converter in order to regulate the voltage Vin above a minimum processor voltage (for example, Vmin). In some embodiments, transistors 1314 and 1316, switching voltage regulator, buck converter, and/or inductor may be operated to control the voltage Vin.

In some embodiments, surge protector 1310 includes an on-die dedicated circuit that monitors voltage Vin (for example, monitors voltage on package decoupling capacitors). In accordance with some embodiments, when this voltage (or its time derivative, or its time integral, or a combination of two or more of the voltage, its time derivative, and its time integral) crosses a pre-defined threshold (for example, crosses threshold voltage Vth), the throttle signal is sent to request throttling of the processor 1302 in order to throttle the processor 1302 to protect the input voltage Vin, and a path connecting the processor 1302 to an alternative power source (for example, a path including the switching voltage regulator and/or buck converter) is switched to low impedance, allowing additional current flow to the processor 1302.

Processor VID (for example, CPU VID) can typically be calculated based on:

VID=Vmin+TOB+Imax*LL3+CMV

Where VID is a voltage identification, core voltage, and/or functional voltage, etc.

Vmin is a minimum voltage such as a minimum core voltage.

TOB is a voltage tolerance band relating to motherboard voltage regulator (VR) tolerance due to ripple, DC voltage offset, and load line error, for example.

Imax*LL3 is due to an Intel Mobile Voltage Positioning (IMVP) tolerance band relating, for example, to a technology where the processor voltage is dynamically adjusted by the motherboard voltage regulator (VR), based on the processor activity, to reduce processor power.

Imax is a peak current such as a peak core current.

LL3 is a motherboard load line.

CMV is circuit marginality validation (for example, a manufacturing guard band which includes a guard band for a second droop LL2 and/or potential differences in package/die voltages between the cores).

In some embodiments, for example, some of the portions of the guard band are ignored, with VID setting eliminating a lot of guard band and attempting to get closer to Vmin. This can help to reduce power consumption.

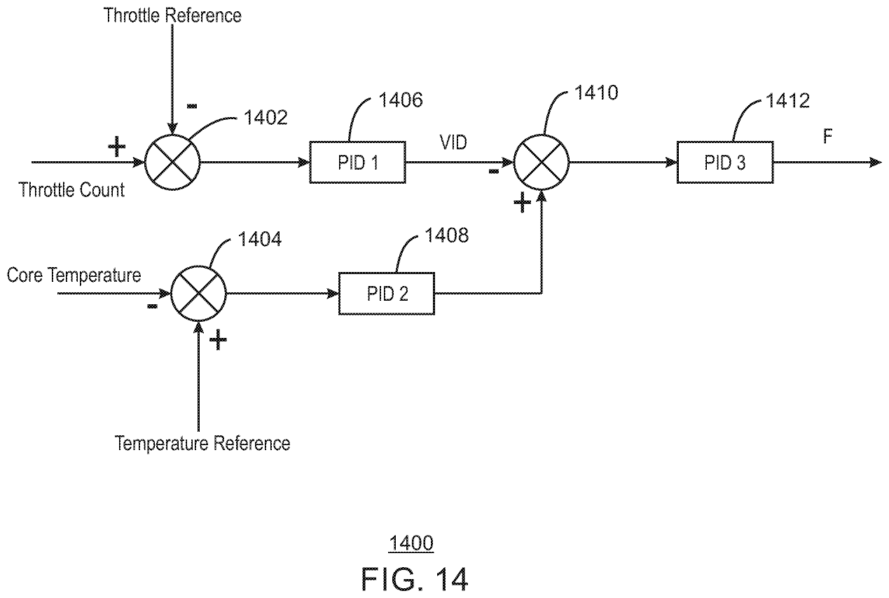

FIG. 14 illustrates a block diagram of a PID (proportional-integral-derivative) controller system 1400 in accordance with some embodiments. PID system 1400 includes a summation 1402, a summation 1404, a PID 1 result 1406, a PID 2 result 1408, a summation 1410, and a PID 3 result 1412. Summation 1402 adds throttle count and subtracts a throttle reference to obtain a corresponding PID 1 result 1406. PID 1 result 1406 can also correspond to a VID (for example, voltage identification, core voltage, and/or functional voltage, etc.) Summation 1404 adds a temperature reference and subtracts a core temperature to obtain a corresponding PID 2 result 1408. Summation 1410 adds the PID 2 result 1408 and subtracts the PID 1 result 1406 (VID) to obtain a corresponding PID 3 result 1412, which can correspond to a frequency F.

System 1400 can be implemented in accordance with some embodiments to provide a feedback mechanism. For example, if VID is aggressively lowered and an application is being run by the processor that consumes a lot of power, a lot of throttling may occur in accordance with some embodiments. System 1400 can be used in such a situation to monitor how much throttling is occurring. If system 1400 identifies that a lot of throttling is occurring (for example, using summation 1402), system 1400 can also then determine that the VID may need to be increased. Although increasing the VID may sacrifice power, it may be beneficial in certain circumstances. For example, when VID is increased, the processor frequency may be increased by system 1400. However, in some embodiments, when VID is increased, it may be beneficial to lower frequency (at least for some time period). Additionally, in some embodiments, when VID is increased, system 1400 may maintain frequency at the same level. Further, in some embodiments, the summation 1402 and PID 1 1406 can be in a separate loop from the rest of system 1400. That is, in some embodiments, temperature sensing and frequency adjustment can be in one loop, and throttle count and VID determination can be in a separate loop.

In some embodiments, system 1400 can determine that the processor temperature (and/or core temperature) is getting high (for example, using summation 1404). In such a situation, according to some embodiments, system 1400 can lower the processor frequency if the processor (and/or processor core) is getting too hot. Similarly, in some embodiments, if the processor (and/or processor core) is cool (for example, is below a certain temperature), the processor frequency may be increased.

In some embodiments, system 1400 may be enabled using artificial intelligence (AI) and/or learning algorithms, although system 1400 may also be enabled using simple PID. System 1400 illustrates a basic implementation, and other implementations are possible in accordance with some embodiments.

In some embodiments, if Cdyn (dynamic capacitance) is higher in some applications, and if there are a significant number of throttling events, the processor can learn to mitigate over time, for example, by temporarily increasing the motherboard VID, by allowing the processor to dissipate more power for some durations, and/or if benefits do not exist after some time duration of operation, by lowering the processor frequency (for example, the processor frequency F). In any case, the processor has options to further optimize performance in accordance with some embodiments. In some embodiments, closed loop operation may rely on increasing the VID if the number of throttling events is too high, decreasing the VID if the number of throttling events is too low. In some embodiments, the core temperature and the VID may also effect the core frequency. In some embodiments, code of a processor (for example, pcode) may modify the VID directly if it is expected that the code will require a sufficiently high load such that there will be a high number of throttling events.

In some embodiments, power rails for a processor (for example, for small cores) may be more easily merged, since required VID voltage for the highest consumer may be decreased. In some embodiments, the voltage can be reduced even further at the risk of throttling for some applications while still supporting required performance margins. In some embodiments, merging of power rails can dramatically decrease platform power delivery (PD) area and cost. In some embodiments, power rail merging may be implemented without a high power penalty using techniques described herein.

In some embodiments, surge protection (and/or surge protectors) as illustrated and described herein may be implemented in a variety of locations in a system. For example, in some embodiments, surge protection and/or surge protectors as illustrated and described herein may be implemented in one or more of a processor, a CPU, a processor core, a CPU core, an SoC, a package, a chip set, a platform controller hub (PCH), a controller, a power controller, and/or on a motherboard, for example. In some embodiments, surge protection and/or surge protectors may be designed to deal with voltage droops of high frequency (for example, in some embodiments, in a MHz range). In some embodiments, surge protection and/or surge protectors may be implemented in low power operation (for example, enabling lower of power consumption such as processor power consumption rather than increasing performance). In some embodiments, throttling of a processor is implemented in a fast throttling manner (for example, faster than 1 μs).

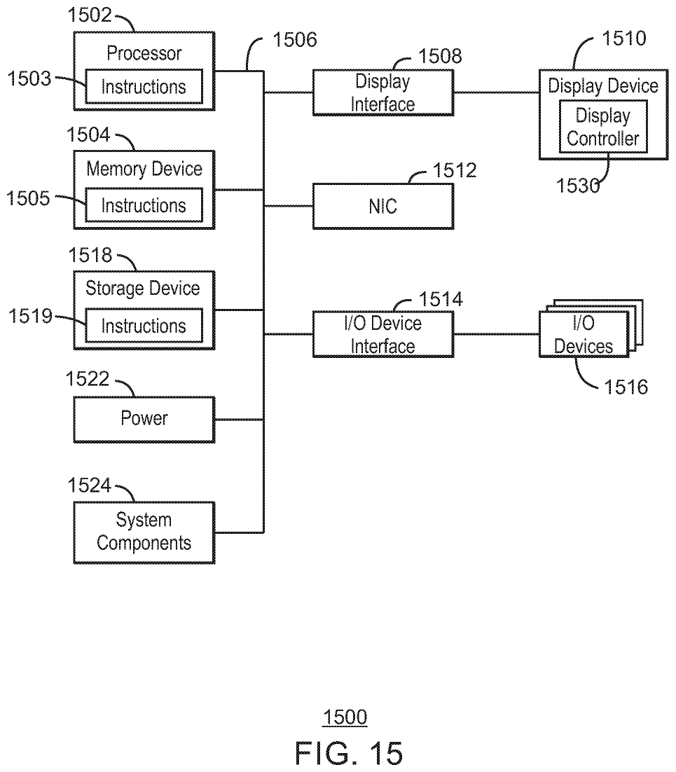

FIG. 15 illustrates a computing system 1500 in accordance with some embodiments. FIG. 15 is a block diagram of an example of a computing device 1500 in accordance with some embodiments. In some embodiments, computing device 1500 may be a computing device including one or more elements of any of the systems described and/or illustrated herein. In some embodiments, computing device 1500 can implement any of the techniques described herein. For example, computing device 1500 can implement throttling a processor to protect input voltage, threshold voltage protection, surge protection, and/or can include a surge protector as illustrated and/or described herein. In some embodiments, one or more elements of computing device 1500 can be the same as or similar to, or can include portions of systems 100, 200, 300, 500, 800, 900, 1000, 1100, 1200, 1300, and/or 1500, for example.

In some embodiments, any portion of the flow, circuits or systems illustrated in any one or more of the figures, and any of the embodiments described herein can be included in or be implemented by computing device 1500. The computing device 1500 may be, for example, a computing device, a controller, a control unit, an application specific controller, and/or an embedded controller, among others.

The computing device 1500 may include a processor 1502 that is adapted to execute stored instructions (for example, instructions 1503), as well as a memory device 1504 (or storage 1504) that stores instructions 1505 that are executable by the processor 1502. The processor 1502 can be a single core processor, a multi-core processor, a computing cluster, or any number of other configurations. For example, processor 1502 can be an Intel® processor such as an Intel® Celeron, Pentium, Core, Core i3, Core i5, or Core i7 processor. In some embodiments, processor 1502 can be an Intel® x86 based processor. In some embodiments, processor 1502 can be an ARM based processor. The memory device 1504 can be a memory device or a storage device, and can include volatile storage, non-volatile storage, random access memory, read only memory, flash memory, or any other suitable memory or storage systems. The instructions that are executed by the processor 602 may also be used to implement any of the techniques as described in this specification and/or illustrated in the drawings. In some embodiments, processor 1502 may include the same or similar features or functionality as, for example, various controllers or agents in this disclosure.

The processor 1502 may also be linked through the system interconnect 1506 (e.g., PCI®, PCI-Express®, NuBus, etc.) to a display interface 1508 adapted to connect the computing device 1500 to a display device 1510. The display device 1510 may include a display controller 1530. Display device 1510 may also include a display screen that is a built-in component of the computing device 1500. The display device may also include a computer monitor, television, or projector, among others, that is externally connected to the computing device 1500. In some embodiments, computing device 1500 does not include a display interface or a display device.

In some embodiments, the display interface 1508 can include any suitable graphics processing unit, transmitter, port, physical interconnect, and the like. In some examples, the display interface 1508 can implement any suitable protocol for transmitting data to the display device 1510. For example, the display interface 1508 can transmit data using a high-definition multimedia interface (HDMI) protocol, a DisplayPort protocol, or some other protocol or communication link, and the like

In addition, a network interface controller (also referred to herein as a NIC) 1512 may be adapted to connect the computing device 1500 through the system interconnect 1506 to a network (not depicted). The network (not depicted) may be a cellular network, a radio network, a wide area network (WAN), a local area network (LAN), or the Internet, among others.

The processor 1502 may be connected through system interconnect 1506 to an input/output (I/O) device interface 1514 adapted to connect the computing host device 1500 to one or more I/O devices 1516. The I/O devices 1516 may include, for example, a keyboard or a pointing device, where the pointing device may include a touchpad or a touchscreen, among others. The I/O devices 1516 may be built-in components of the computing device 1500, or may be devices that are externally connected to the computing device 1500.

In some embodiments, the processor 1502 may also be linked through the system interconnect 1506 to a storage device 1518 that can include a hard drive, a solid-state drive (SSD), a magnetic drive, an optical drive, a USB flash drive, an array of drives, or any other type of storage, including combinations thereof. In some embodiments, the storage device 1518 can include any suitable applications that can be used by processor 1502 to implement any of the techniques described herein. In some embodiments, storage 1518 stores instructions 1519 that are executable by the processor 1502. In some embodiments, the storage device 1518 can include a basic input/output system (BIOS).

In some embodiments, a power device 1522 is provided. For example, in some embodiments, power device 1522 can implement throttling a processor to protect input voltage, threshold voltage protection, surge protection, and/or can include a surge protector as illustrated and/or described herein. In some embodiments, power 1522 can include one or more sources of power supply such as one or more power supply units (PSUs). In some embodiments, power 1522 can be a part of system 1500, and in some embodiments, power 1522 can be external to the rest of system 1500. In some embodiments, power 1522 can provide any of the techniques described herein. For example, in some embodiments, power 1522 can provide any of the techniques as described in reference to or illustrated in any of the drawings herein.

FIG. 15 also illustrates system components 1524. In some embodiments, system components 1524 can include any of display, camera, audio, storage, modem, or memory components, or any additional system components. In some embodiments, system components 1524 can include any system components for which power, voltage, power management, etc. can be implemented according to some embodiments as described herein.

It is to be understood that the block diagram of FIG. 15 is not intended to indicate that the computing device 1500 is to include all of the components shown in FIG. 15 in all embodiments. Rather, the computing device 1500 can include fewer or additional components not illustrated in FIG. 15 (e.g., additional memory components, embedded controllers, additional modules, additional network interfaces, etc.). Furthermore, any of the functionalities of power device 1522 may be partially, or entirely, implemented in hardware or in a processor such as processor 1502. For example, the functionality may be implemented with an application specific integrated circuit, logic implemented in an embedded controller, or in logic implemented in the processor 1502, among others. In some embodiments, the functionalities of power device 1522 can be implemented with logic, wherein the logic, as referred to herein, can include any suitable hardware (e.g., a processor, among others), software (e.g., an application, among others), firmware, or any suitable combination of hardware, software, or firmware. In some embodiments, power device 1522 can be implemented with an integrated circuit.

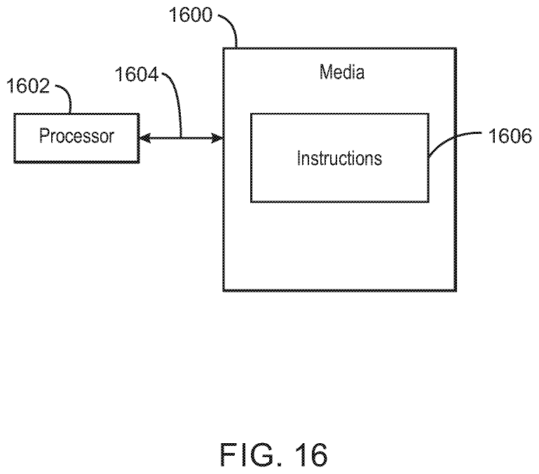

FIG. 16 is a block diagram of an example of one or more processors 1602 and one or more tangible, non-transitory computer readable media 1600 for throttling a processor to protect input voltage, threshold voltage protection, surge protection, etc. as illustrated and/or described herein. The one or more tangible, non-transitory, computer-readable media 1600 may be accessed by the processor(s) 1602 over a computer interconnect 1604. Furthermore, the one or more tangible, non-transitory, computer-readable media 1600 may include instructions (or code) 1606 to direct the processor(s) 1602 to perform operations as described herein. In some embodiments, processor 1602 is one or more processors. In some embodiments, processor(s) 1602 can perform some or all of the same or similar functions that can be performed by other elements described herein using instructions (code) 1606 included on media 1600 (for example, some or all of the functions or techniques illustrated in or described in reference to any of FIGS. 1-15). In some embodiments, one or more of processor(s) 1602 may include the same or similar features or functionality as, for example, various controllers, units, or agents, etc. described in this disclosure. In some embodiments, one or more processor(s) 1602, interconnect 1604, and/or media 1600 may be included in computing device 1500.

Various components discussed in this specification may be implemented using software components. These software components may be stored on the one or more tangible, non-transitory, computer-readable media 1600, as indicated in FIG. 16. For example, instructions 1606 may be adapted to direct the processor(s) 1602 to perform one or more of any of the operations described in this specification and/or in reference to the drawings.

It is to be understood that any suitable number of software components may be included within the one or more tangible, non-transitory computer-readable media 1600. Furthermore, any number of additional software components shown or not shown in FIG. 16 may be included within the one or more tangible, non-transitory, computer-readable media 1600, depending on the specific application.

The various techniques and/or operations described herein (for example, in reference to any one or more of FIGS. 1-16) may be performed by a control unit comprised of one or more processors, monitoring logic, control logic, software, firmware, agents, controllers, logical software agents, system agents, and/or other modules. For example, in some embodiments, some or all of the techniques and/or operations described herein may be implemented by a system agent. Due to the variety of modules and their configurations that may be used to perform these functions, and their distribution through the system and/or in a different system, they are not all specifically illustrated in their possible locations in the figures.

Reference in the specification to “one embodiment” or “an embodiment” or “some embodiments” of the disclosed subject matter means that a particular feature, structure, or characteristic described in connection with the embodiment is included in at least one embodiment of the disclosed subject matter. Thus, the phrase “in one embodiment” or “in some embodiments” may appear in various places throughout the specification, but the phrase may not necessarily refer to the same embodiment or embodiments.

Example 1 In some examples, a voltage protection apparatus includes a circuit to compare an input voltage of a processor to a threshold voltage, and to provide a throttle signal to the processor if the input voltage of the processor droops below the threshold voltage.

Example 2 includes the subject matter of example 1. The circuit is to provide power to maintain the input voltage of the processor at the threshold voltage or slightly above the threshold voltage.

Example 3 includes the subject matter of any of examples 1-2. The circuit is to set the input voltage of the processor at a level below a level required by the maximum processor current and minimum processor voltage without risk of violating the minimum processor voltage.

Example 4 includes the subject matter of any of examples 1-3. The circuit is to de-assert the throttle signal after a time delay.

Example 5 includes the subject matter of any of examples 1-4. the circuit is to provide an alternate voltage to the input voltage of the processor in response to the throttle signal.

Example 6 includes the subject matter of any of examples 1-5. The circuit is to overcome an overshoot condition.

Example 7 includes the subject matter of any of examples 1-6. The circuit includes a first switch to provide the alternate voltage to the input voltage of the processor in response to the throttle signal, and a second switch to overcome the overshoot condition.

Example 8 includes the subject matter of any of examples 1-7. The first switch and the second switch control the input voltage of the processor in a hysteretic mode of operation.

Example 9 includes the subject matter of any of examples 1-8. The circuit includes an array of switches with high resistance and a controller to turn on and off at least some of the switches to maintain the input voltage of the processor at a voltage relative to the threshold voltage.

Example 10 includes the subject matter of any of examples 1-9. The circuit includes a linear regulator and a controller to control a resistance of the linear regulator to maintain the input voltage of the processor.

Example 11 includes the subject matter of any of examples 1-10. The circuit includes a switching voltage regulator to maintain the input voltage of the processor.

Example 12 includes the subject matter of any of examples 1-11. The circuit includes a buck converter to maintain the input voltage of the processor.

Example 13 includes the subject matter of any of examples 1-12. The circuit is to adjust the threshold voltage in response to a number of throttles of the processor.

Example 14 includes the subject matter of any of examples 1-13. The circuit is to adjust a frequency of the processor in response to a number of throttles of the processor.

Example 15 includes the subject matter of any of examples 1-14. The circuit is to adjust a frequency of the processor in response to a temperature of the processor.

Example 16 includes the subject matter of any of examples 1-15. The circuit is included in or on one or more of a processor, a CPU, a processor core, a CPU core, an SoC, a package, a chip set, a platform controller hub (PCH), a controller, a power controller, and a motherboard.

Example 17 In some examples, a method can protect voltage. The method can include comparing an input voltage of a processor to a threshold voltage, and can include providing a throttle signal to the processor if the input voltage of the processor droops below the threshold voltage.

Example 18 includes the subject matter of example 17. The method includes providing power to maintain the input voltage of the processor at the threshold voltage or slightly above the threshold voltage.

Example 19 includes the subject matter of any of examples 17-18. The method includes setting the input voltage of the processor at a level below a level required by the maximum processor current and minimum processor voltage without risk of violating the minimum processor voltage.

Example 20 includes the subject matter of any of examples 17-19. The method includes de-asserting the throttle signal after a time delay.

Example 21 includes the subject matter of any of examples 17-20. The method includes providing an alternate voltage to the input voltage of the processor in response to the throttle signal.

Example 22 includes the subject matter of any of examples 17-21. The method includes overcoming an overshoot condition.

Example 23 includes the subject matter of any of examples 17-22. The method includes switching to provide an alternate voltage to the input voltage of the processor in response to the throttle signal, and switching to overcome an overshoot condition.

Example 24 includes the subject matter of any of examples 17-23. The method includes controlling the input voltage of the processor in a hysteretic mode of operation.

Example 25 includes the subject matter of any of examples 17-24. The method includes turning on and off at least some switches of an array of switches to maintain the input voltage of the processor at a voltage relative to the threshold voltage.

Example 26 includes the subject matter of any of examples 17-25. The method includes linearly regulating and controlling a resistance to maintain the input voltage of the processor.

Example 27 includes the subject matter of any of examples 17-26. The method includes switching voltage regulating to maintain the input voltage of the processor.

Example 28 includes the subject matter of any of examples 17-27. The method includes buck converting to maintain the input voltage of the processor.

Example 29 includes the subject matter of any of examples 17-28. The method includes adjusting the threshold voltage in response to a number of throttles of the processor.

Example 30 includes the subject matter of any of examples 17-29. The method includes adjusting a frequency of the processor in response to a number of throttles of the processor.

Example 31 includes the subject matter of any of examples 17-30. The method includes adjusting a frequency of the processor in response to a temperature of the processor.

Example 32 In some examples, a voltage protection system includes a processor and a circuit to compare an input voltage of the processor to a threshold voltage, and to provide a throttle signal to the processor if the input voltage of the processor droops below the threshold voltage.

Example 33 includes the subject matter of example 32. The circuit is to provide power to maintain the input voltage of the processor at the threshold voltage or slightly above the threshold voltage.

Example 34 includes the subject matter of any of examples 32-33. The circuit is to set the input voltage of the processor at a level below a level required by the maximum processor current and minimum processor voltage without risk of violating the minimum processor voltage.

Example 35 includes the subject matter of any of examples 32-34. The circuit is to de-assert the throttle signal after a time delay.

Example 36 includes the subject matter of any of examples 32-35. The circuit is to provide an alternate voltage to the input voltage of the processor in response to the throttle signal.

Example 37 includes the subject matter of any of examples 32-36. The circuit is to overcome an overshoot condition.

Example 38 includes the subject matter of any of examples 32-37. The circuit includes a first switch to provide the alternate voltage to the input voltage of the processor in response to the throttle signal, and a second switch to overcome the overshoot condition.

Example 39 includes the subject matter of any of examples 32-38. The first switch and the second switch control the input voltage of the processor in a hysteretic mode of operation.

Example 40 includes the subject matter of any of examples 32-39. The circuit includes an array of switches with high resistance and a controller to turn on and off at least some of the switches to maintain the input voltage of the processor at a voltage relative to the threshold voltage.

Example 41 includes the subject matter of any of examples 32-40. The circuit includes a linear regulator and a controller to control a resistance of the linear regulator to maintain the input voltage of the processor.

Example 42 includes the subject matter of any of examples 32-41. The circuit includes a switching voltage regulator to maintain the input voltage of the processor.

Example 43 includes the subject matter of any of examples 32-42. The circuit includes a buck converter to maintain the input voltage of the processor.

Example 44 includes the subject matter of of any of examples 32-43. The circuit is to adjust the threshold voltage in response to a number of throttles of the processor.

Example 45 includes the subject matter of of any of examples 32-44. The circuit is to adjust a frequency of the processor in response to a number of throttles of the processor.

Example 46 includes the subject matter of any of examples 32-45. The circuit is to adjust a frequency of the processor in response to a temperature of the processor.

Example 47 includes the subject matter of any of examples 32-46. The circuit is included in or on one or more of a processor, a CPU, a processor core, a CPU core, an SoC, a package, a chip set, a platform controller hub (PCH), a controller, a power controller, and a motherboard.

Example 48 In some examples, a voltage protection apparatus includes means for comparing an input voltage of a processor to a threshold voltage, and means for providing a throttle signal to the processor if the input voltage of the processor droops below the threshold voltage.

Example 49 includes the subject matter of example 48. The voltage protection apparatus includes means for providing power to maintain the input voltage of the processor at the threshold voltage or slightly above the threshold voltage.

Example 50 includes the subject matter of any of examples 48-49. The voltage protection apparatus includes means for setting the input voltage of the processor at a level below a level required by the maximum processor current and minimum processor voltage without risk of violating the minimum processor voltage.

Example 51 includes the subject matter of any of examples 48-50. The voltage protection apparatus includes means for de-asserting the throttle signal after a time delay.

Example 52 includes the subject matter of any of examples 48-51. The voltage protection apparatus includes means for providing an alternate voltage to the input voltage of the processor in response to the throttle signal.

Example 53 includes the subject matter of any of examples 48-52. The voltage protection apparatus includes means for overcoming an overshoot condition.

Example 54 includes the subject matter of any of examples 48-53. The voltage protection apparatus includes means for providing the alternate voltage to the input voltage of the processor in response to the throttle signal, and means for overcoming an overshoot condition.

Example 55 includes the subject matter of any of examples 48-54. The voltage protection apparatus includes means for providing the alternate voltage to the input voltage of the processor in response to the throttle signal, means for overcoming an overshoot condition, and means for controlling the input voltage of the processor in a hysteretic mode of operation.

Example 56 includes the subject matter of any of examples 48-55. The voltage protection apparatus includes array switching means with high resistance, and means for turning on and off at least some of the array switching means to maintain the input voltage of the processor at a voltage relative to the threshold voltage.

Example 57 includes the subject matter of any of examples 48-56. The voltage protection apparatus includes linear regulator means, and means for controlling a resistance of the linear regulator means to maintain the input voltage of the processor.

Example 58 includes the subject matter of any of examples 48-57. The voltage protection apparatus includes switching voltage regulator means for maintaining the input voltage of the processor.

Example 59 includes the subject matter of any of examples 48-58. The voltage protection apparatus includes buck converter means for maintaining the input voltage of the processor.

Example 60 includes the subject matter of any of examples 48-59. The voltage protection apparatus includes means for adjusting the threshold voltage in response to a number of throttles of the processor.

Example 61 includes the subject matter of any of examples 48-60. The voltage protection apparatus includes means for adjusting a frequency of the processor in response to a number of throttles of the processor.

Example 62 includes the subject matter of any of examples 48-61. The voltage protection apparatus includes means for adjusting a frequency of the processor in response to a temperature of the processor.

Example 63 includes the subject matter of any of examples 48-62. The voltage protection apparatus is in or on one or more of a processor, a CPU, a processor core, a CPU core, an SoC, a package, a chip set, a platform controller hub (PCH), a controller, a power controller, and a motherboard.

Example 64 In some examples, one or more tangible, non-transitory machine readable media includes a plurality of instructions that, in response to being executed on at least one processor, cause the at least one processor to compare an input voltage of a processor (for example, either the same processor, or another processor) to a threshold voltage, and provide a throttle signal to the processor (to the same or to the another processor) if the input voltage of the processor (input voltage of the same processor or input voltage of the another processor) droops below the threshold voltage.

Example 65 includes the subject matter of example 64. The method one or more tangible, non-transitory machine readable media includes a plurality of instructions that, in response to being executed on at least one processor, cause the at least one processor to provide power to maintain the input voltage of the processor at the threshold voltage or slightly above the threshold voltage.

Example 66 includes the subject matter of any of examples 64-65. The one or more tangible, non-transitory machine readable media include a plurality of instructions that, in response to being executed on at least one processor, cause the at least one processor to set the input voltage of the processor at a level below a level required by the maximum processor current and minimum processor voltage without risk of violating the minimum processor voltage.

Example 67 includes the subject matter of any of examples 64-66. The one or more tangible, non-transitory machine readable media include a plurality of instructions that, in response to being executed on at least one processor, cause the at least one processor to de-assert the throttle signal after a time delay.

Example 68 includes the subject matter of any of examples 64-67. The one or more tangible, non-transitory machine readable media include a plurality of instructions that, in response to being executed on at least one processor, cause the at least one processor to provide an alternate voltage to the input voltage of the processor in response to the throttle signal.

Example 69 includes the subject matter of any of examples 64-68. The one or more tangible, non-transitory machine readable media include a plurality of instructions that, in response to being executed on at least one processor, cause the at least one processor to overcome an overshoot condition. Example 70 includes the subject matter of any of examples 64-69. The one or more tangible, non-transitory machine readable media include a plurality of instructions that, in response to being executed on at least one processor, cause the at least one processor to provide an alternate voltage to the input voltage of the processor in response to the throttle signal, and overcome an overshoot condition.

Example 71 includes the subject matter of any of examples 64-70. The one or more tangible, non-transitory machine readable media include a plurality of instructions that, in response to being executed on at least one processor, cause the at least one processor to control the input voltage of the processor in a hysteretic mode of operation.

Example 72 includes the subject matter of any of examples 64-71. The one or more tangible, non-transitory machine readable media include a plurality of instructions that, in response to being executed on at least one processor, cause the at least one processor to turn on and off at least some switches of an array of switches to maintain the input voltage of the processor at a voltage relative to the threshold voltage.

Example 73 includes the subject matter of any of examples 64-72. The one or more tangible, non-transitory machine readable media include a plurality of instructions that, in response to being executed on at least one processor, cause the at least one processor to linearly regulate and control a resistance to maintain the input voltage of the processor.

Example 74 includes the subject matter of any of examples 64-73. The one or more tangible, non-transitory machine readable media include a plurality of instructions that, in response to being executed on at least one processor, cause the at least one processor to switch voltage regulate to maintain the input voltage of the processor.

Example 75 includes the subject matter of any of examples 64-74. The one or more tangible, non-transitory machine readable media include a plurality of instructions that, in response to being executed on at least one processor, cause the at least one processor to buck convert to maintain the input voltage of the processor.

Example 76 includes the subject matter of any of examples 64-75. The one or more tangible, non-transitory machine readable media include a plurality of instructions that, in response to being executed on at least one processor, cause the at least one processor to adjust the threshold voltage in response to a number of throttles of the processor.

Example 77 includes the subject matter of any of examples 64-76. The one or more tangible, non-transitory machine readable media include a plurality of instructions that, in response to being executed on at least one processor, cause the at least one processor to adjust a frequency of the processor in response to a number of throttles of the processor.

Example 78 includes the subject matter of any of examples 64-77. The one or more tangible, non-transitory machine readable media include a plurality of instructions that, in response to being executed on at least one processor, cause the at least one processor to adjust a frequency of the processor in response to a temperature of the processor.

Example 79 In some examples, an apparatus including means to perform a method as in any other example.

Example 80 In some examples, a system including means to perform a method as in any other example.

Example 81 In some examples, machine-readable storage including machine-readable instructions, when executed, to implement a method or realize an apparatus as in any other example.

Example 82 In some examples, one or more machine readable medium include(s) code, when executed, to cause a machine to perform the method of any other example.

Although example embodiments and examples of the disclosed subject matter are described with reference to circuit diagrams, flow diagrams, block diagrams etc. in the drawings, persons of ordinary skill in the art will readily appreciate that many other ways of implementing the disclosed subject matter may alternatively be used. For example, the arrangements of the elements in the diagrams, or the order of execution of the blocks in the diagrams may be changed, or some of the circuit elements in circuit diagrams, and blocks in block/flow diagrams described may be changed, eliminated, or combined. Any elements as illustrated or described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

Program code may represent hardware using a hardware description language or another functional description language which essentially provides a model of how designed hardware is expected to perform. Program code may be assembly or machine language or hardware-definition languages, or data that may be compiled or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, one or more volatile or non-volatile memory devices, such as storage devices or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile or non-volatile memory readable by the processor, at least one input device or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, or in a distributed environment, and with program code stored locally or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter. For example, in each illustrated embodiment and each described embodiment, it is to be understood that the diagrams of the figures and the description herein is not intended to indicate that the illustrated or described devices include all of the components shown in a particular figure or described in reference to a particular figure. In addition, each element may be implemented with logic, wherein the logic, as referred to herein, can include any suitable hardware (e.g., a processor, among others), software (e.g., an application, among others), firmware, or any suitable combination of hardware, software, and firmware, for example.

What is claimed is:

1. A voltage protection apparatus comprising:
a circuit to compare an input voltage of a processor to a threshold voltage, and to provide a throttle signal to the processor if the input voltage of the processor droops below the threshold voltage.

2. The voltage protection apparatus of claim 1, wherein the circuit is to provide power to maintain the input voltage of the processor at the threshold voltage or slightly above the threshold voltage.

3. The voltage protection apparatus of claim 1, wherein the circuit is to set the input voltage of the processor at a level below a level required by the maximum processor current and minimum processor voltage without risk of violating the minimum processor voltage.

4. The voltage protection apparatus of claim 1, the circuit to de-assert the throttle signal after a time delay.

5. The voltage protection apparatus of claim 1, wherein the circuit is to provide an alternate voltage to the input voltage of the processor in response to the throttle signal.

6. The voltage protection apparatus of claim 5, wherein the circuit is to overcome an overshoot condition.

7. The voltage protection apparatus of claim 6, wherein the circuit includes a first switch to provide the alternate voltage to the input voltage of the processor in response to the throttle signal, and a second switch to overcome the overshoot condition.

8. The voltage protection apparatus of claim 7, wherein the first switch and the second switch control the input voltage of the processor in a hysteretic mode of operation.

9. The voltage protection apparatus of claim 1, the circuit including an array of switches with high resistance and a controller to turn on and off at least some of the switches to maintain the input voltage of the processor at a voltage relative to the threshold voltage.

10. The voltage protection apparatus of claim 1, the circuit including a linear regulator and a controller to control a resistance of the linear regulator to maintain the input voltage of the processor.

11. The voltage protection apparatus of claim 1, the circuit including a switching voltage regulator to maintain the input voltage of the processor.

12. The voltage protection apparatus of claim 1, the circuit including a buck converter to maintain the input voltage of the processor.

13. The voltage protection apparatus of claim 1, the circuit to adjust the threshold voltage in response to a number of throttles of the processor.

14. The voltage protection apparatus of claim 1, the circuit to adjust a frequency of the processor in response to a number of throttles of the processor.

15. The voltage protection apparatus of claim 1, the circuit to adjust a frequency of the processor in response to a temperature of the processor.

16. The voltage protection apparatus of claim 1, wherein the circuit is included in or on one or more of a processor, a CPU, a processor core, a CPU core, an SoC, a package, a chip set, a platform controller hub (PCH), a controller, a power controller, and a motherboard.

17. A voltage protection method comprising:
comparing an input voltage of a processor to a threshold voltage; and
providing a throttle signal to the processor if the input voltage of the processor droops below the threshold voltage.

18. The voltage protection method of claim 17, comprising providing power to maintain the input voltage of the processor at the threshold voltage or slightly above the threshold voltage.

19. The voltage protection method of claim 17, comprising setting the input voltage of the processor at a level below a level required by the maximum processor current and minimum processor voltage without risk of violating the minimum processor voltage.

20. A voltage protection system comprising:
a processor; and
a circuit to compare an input voltage of the processor to a threshold voltage, and to provide a throttle signal to the processor if the input voltage of the processor droops below the threshold voltage.

21. The voltage protection system of claim 20, wherein the circuit is to provide power to maintain the input voltage of the processor at the threshold voltage or slightly above the threshold voltage.

22. The voltage protection system of claim 20, wherein the circuit is to set the input voltage of the processor at a level below a level required by the maximum processor current and minimum processor voltage without risk of violating the minimum processor voltage.

23. One or more tangible, non-transitory machine readable media comprising a plurality of instructions that, in response to being executed on at least one processor, cause the at least one processor to:
compare an input voltage of a processor to a threshold voltage; and
provide a throttle signal to the processor if the input voltage of the processor droops below the threshold voltage.

24. The one or more tangible, non-transitory machine readable media of claim 23, comprising a plurality of instructions that, in response to being executed on at least one processor, cause the at least one processor to:
provide power to maintain the input voltage of the processor at the threshold voltage or slightly above the threshold voltage.

25. The one or more tangible, non-transitory machine readable media of claim 23, comprising a plurality of instructions that, in response to being executed on at least one processor, cause the at least one processor to:
set the input voltage of the processor at a level below a level required by the maximum processor current and minimum processor voltage without risk of violating the minimum processor voltage.
